(19) United States
(12) Patent Application Publication
(10) Pub. No.: US 2006/0075355 A1
(43) Pub. Date: Apr. 6, 2006

(54) Interface and interface program executed by a computer

(75) Inventors: Fusahiro Shiono, Osaka (JP); Yoshiaki Tanaka, Kyoto (JP); Takashi Sawano, Osaka (JP)

Correspondence Address: EDWARDS & ANGELL, LLP, P.O. BOX 55874, BOSTON, MA, 02205, US

(73) Assignee: Sharp Kabushiki Kaisha

(21) Appl. No.: 11/243,894

(22) Filed: Oct. 4, 2005

(30) Foreign Application Priority Data
Oct. 6, 2004 (JP) 2004-293918
Mar. 16, 2005 (JP) 2005-075440

(51) Int. Cl. G06F 3/00

(52) U.S. Cl. 715/778; 715/864; 715/810

(57) ABSTRACT

The interface according to an embodiment for displaying icons or indicators corresponding to a plurality of functions on a screen and selectively pointing each icon or indicator on the screen, comprises a display controlling means for displaying a rotator on the screen, placing each icon or indicator on the circumferential face of the rotator, and sequentially displaying each icon or indicator by rotating the rotator, and an input operating means for selectively pointing an icon or indicator on the circumferential face of the rotator.

### CROSS-REFERENCE TO RELATED APPLICATION

This application claims priority under 35 U.S.C. § 119(a) on Patent Application No. 2004-293918 filed in Japan on Oct. 6, 2004 and Patent Application No. 2005-075440 filed in Japan on Mar. 16, 2005, the entire contents of which are hereby incorporated by reference.

### BACKGROUND OF THE INVENTION

1. Field of the Invention

The present invention relates to interfaces and interface programs executable on computers which selectively point a plurality of icons, etc. on a screen.

2. Related Art

Conventional interfaces of this type exist which display an array of a plurality of icons on a screen of a displaying device, select and point a desired icon, for example, by operating a pointing device, and launch an application and other type of software which corresponds to the icon.

However, in the case of a small screen, the plurality of icons must be arrayed without gaps in between, making the visibility of the icons poor and making the icon selection operation difficult.

Furthermore, not all icons are displayed and presented, so in some cases there exist unknown icons and functions corresponding to these icons which are left unused.

For this reason, as disclosed in JP H11-102277A, improved ease of use is attempted by displaying a polygon on the screen, arranging at least one icon along each face of the polygon, and displaying the icon on each face of the polygon sequentially by rotating the polygon in increments of 90° through operation of a pointing device.

However, with the above-mentioned conventional interface, a plurality of operations are needed to see all faces of the polygon to rotate the polygon in increments of 90° by operating the pointing device. This operation is also required to return to the desired face after viewing all the faces of the polygon. The operation of the pointing device is therefore complicated.

### SUMMARY OF THE INVENTION

The present invention was arrived at in light of the foregoing existing issues, and it is an object thereof to provide an interface and interface program executable on a computer sequentially displaying a plurality of icons, etc. and capable of selecting and pointing icons, etc., while being simple to operate.

The interface according to the present invention, which displays icons or indicators corresponding to a plurality of functions on a screen and selectively points each icon or indicator on the screen, comprises a display controlling means for displaying each icon or indicator repeatedly in sequence on the screen and an input operating means for selectively pointing an icon or indicator on the screen.

The interface according to the present invention, which displays a plurality of icons on the screen and selectively points each icon on the screen, may also comprise a display controlling means for displaying a rotator on the screen, placing each icon on a circumferential face of the rotator, and sequentially displaying each icon or indicator by rotating the rotator, and an input operating means for selectively pointing each icon on the circumferential face of the rotator.

Further, in the present invention, the display controlling means may stop the rotation of the rotator when the rotator is instructed to stop by the input operating means.

Further, in the present invention, the speed of rotation or the direction of rotation of the rotator may be changed when the rotator is instructed to change the speed of rotation or the direction of rotation by the input operating means.

Further, in the present invention, when an icon on the circumferential face of the rotator is pointed by the input operating means, the display controlling means may place and display on the circumferential face of the rotator at least one other icon related to the pointed icon.

Further, in the present invention, when an icon on the circumferential face of the rotator is pointed by the input operating means, the display controlling means may enlarge the pointed icon.

Further, in the present invention, when an icon on the circumferential face of the rotator is pointed by the input operating means, the display controlling means may display information related to the pointed icon.

Further, in the present invention, when an instruction to change the position of an icon on the circumferential face of the rotator is given by the input operating means, the display controlling means may change the position of the icon on the circumferential face of the rotator.

Further, in the present invention, when an icon on the circumferential face of the rotator is pointed by the input operating means, the display controlling means may change the display of other icons which are suppressed from being be pointed together with the pointed icon.

Further, in the present invention, the display controlling means may display information related to other icons which cannot be pointed together with the pointed icon.

Further, in the present invention, the display controlling means may display at least one icon pointed by the input operating means in a history information display region which is different from the rotator.

Further, in the present invention, the display controlling means may display on the screen at least one button for controlling operation of the rotator, and control the rotator when this button is operated by the input operating means.

Further, in the present invention, the display controlling means may repeatedly rotate and pause the rotator.

The interface according to the present invention, which displays icons or indicators corresponding to a plurality of functions on a screen and selectively points each icon or indicator on the screen, comprises a display controlling means for forming a display area on the screen and repeatedly displaying each icon or each indicator in sequence in this display area while moving at least one icon or indicator across this display area, and an input operating means for selectively pointing an icon or indicator displayed in this display area.

Further, in the present invention, the display controlling means may intermittently move the icons or the indicators across the display area.

Further, in the present invention, the display controlling means may display a plurality of icons or indicators lined up in one direction in the display area and move these icons or these indicators in the one direction across the display area.

Further, in the present invention, the display controlling means may display a plurality of icons or indicators lined up in one direction in the display area and move these icons or these indicators in synchronization in another direction which intersects with the one direction across the display area.

Further, in the present invention, the plurality of icons or indicators displayed lined up in one direction in the display area may be made up of icons or indicators and other icons or indicators which belong to these icons or indicators.

Further in the present invention, the plurality of icons or indicators displayed lined up in one direction in the display area may be icons or indicators which correspond to a plurality of functions which belongs to the same function group.

Further, in the present invention, the display controlling means may display a plurality of icons or indicators in the display area in rows and columns and move the icons or indicators in synchronization along each row or column across the display area, differentiating the display status of one row or column from the display status of other rows or columns.

For example, the display controlling means may differentiate the display status of one row or column pointed by a cursor on the screen from the display status of other rows or columns.

Further, in the present invention, the input operating means may instruct the display controlling means to enlarge or reduce the display area based on input operations of the input operating means, and the display controlling means may respond to the instruction to enlarge or reduce the display area from the input operating means by enlarging or reducing the display area.

With the present invention, the functions may be functions for controlling a printer, and the interface may be used for controlling the printer.

In the present invention, the icons or indicators may be for setting a printing layout for printed matter to be printed by a printer.

Further, the present invention may be provided with a function executing means for executing functions corresponding to the icons or indicators pointed by the input operating means.

Next, the interface program according to the present invention, which is executable on a computer, for displaying icons or indicators corresponding to a plurality of functions on a screen and selectively pointing each icon or indicator on the screen, includes a display controlling step of displaying each icon or indicator repeatedly in sequence on the screen and an input operating step of selectively pointing an icon or indicator on the screen.

Next, the interface program according to the present invention, which is executable on a computer for displaying icons or indicators corresponding to a plurality of functions on a screen and selectively pointing each icon or indicator on the screen, includes a display controlling step of displaying a rotator on the screen, placing each icon or indicator on circumferential face of the rotator, and sequentially displaying each icon indicator by rotating the rotator, and an input operating step of selectively pointing each icon or indicator on the circumferential face of the rotator.

Further, the interface program according to the present invention, which is executable on a computer, for displaying icons or indicators corresponding to a plurality of functions on a screen and selectively pointing each icon or indicator on the screen, may include a display controlling step of forming a display area on the screen and repeatedly displaying each icon or each indicator in sequence in this display area while moving each icon or indicator across this display area, and an input operating step of selectively pointing an icon or indicator displayed in this display area.

With the interface according to the present invention, icons or indicators are repeatedly displayed in sequence on the screen and the icons or indicators on the screen are selectively pointed by input operating means. For this reason, it is possible to see each icon or indicator in sequence even without a special operation being performed.

The icons are marks designed such that the content of each type of function can be intuitively understood. Moreover, the indicators mentioned here include symbols, codes, character strings, and so on printed such that the content of each type of function can be easily understood.

With the interface according to the present invention, a rotator is displayed on the screen, icons or indicators are placed on a circumferential face of the rotator, the icons or indicators are displayed in sequence by rotating the rotator, and the icons or indicators on the circumferential face of the rotator are selectively pointed by the input operating means, making it possible to see each icon or indicator on the circumferential face of the rotator in sequence as the rotator rotates without a special operation being performed.

Icons or indicators are clearly visible and the operation of selecting an icon or indicator is easy even on small screens because the icons or indicators are placed separated from one another on the circumferential face of the rotator.

Further, if the circumferential face of the rotator are virtually set to be long enough, it is possible to place more icons or indicators on the circumferential face of the rotator, making it possible to present all the icons or indicators and providing the opportunity to use the functions corresponding to those icons or indicators.

Application of a mouse or other kind of pointing device is possible as an input operating means for selectively pointing icons or indicators.

The rotator may be a cylindrical body, a polygonal tube-shaped body, and so on.

Further, with the present invention, the operation of selecting icons or indicators on the circumferential face of the rotator is made simpler because rotation of the rotator stops in response to an instruction from the input operating means.

Further, with the present invention, any icon or indicator on the circumferential face of the rotator can easily be viewed because the speed of rotation or the direction of rotation of the rotator changes in response to an instruction from the input operating means. For example, when selectively pointing an icon or indicator, the speed of rotation of the rotator may be slowed. If, on the other hand, the speed of rotation of the rotator is slow and it is taking a long time to view all the icons or indicators on the circumferential face of the rotator, the speed of rotation of the rotator may be sped up. Further, if the desired icon or indicator passes by, the direction of rotation of the rotator may be changed to return to the desired icon or indicator in a short time.

Further, in the present invention, when an icon or indicator on the circumferential face of the rotator is pointed by the input operating means, at least one other icon or indicator related to the pointed icon or indicator is placed and displayed on the circumferential face of the rotator. For example, other icons or indicators which are shown include functions which can be used together with the function corresponding to the pointed icon or indicator. For example, in application software for printers, the layout of text on a page or how to bind a page can be set, and therefore, when an icon or indicator is pointed for the function for setting the layout of text on a page, an icon or indicator for the function for setting how to bind the page is indicated. This improves the usability of the interface.

Further, with the present invention, when an icon or indicator on the circumferential face of the rotator is pointed by the input operating means, the pointed icon or indicator is displayed enlarged. This makes it possible to display more clearly the pointed icon or indicator.

Further, with the present invention, when an icon or indicator on the circumferential face of the rotator is pointed by the input operating means, information related to the pointed icon or indicator is displayed. For example, menu items or descriptions of the function corresponding to the icon or indicator are displayed. This improves the usability of the interface.

Further, with the present invention, the position of the icons or indicators on the circumferential face of the rotator change in response to instructions from the input operating means. The user can thus arrange the icons or indicators on the circumferential face of the rotator in any order, thereby improving the operating environment.

Further, in the present invention, when an icon or indicator on the circumferential face of the rotator is pointed by the input operating means, the display of other icons or indicators which cannot be pointed together with the pointed icon or indicator is changed. The user can thus find out which icons or indicators cannot be used together with the desired icon or indicator when that icon or indicator is pointed, making it possible to avoid wastefull operation.

In this case, information related to icons or indicators which cannot be pointed together with the pointed icon or indicator may be displayed. For example, the reason the icon or indicator cannot be pointed is displayed.

Further, with the present invention, at least one icon or indicator pointed by the input operating means is displayed in a history information display region which is different from the rotator. For example, if a plurality of icons or indicators are selected in sequence, these icons or indicators are displayed in the history information display region. This way, the selected icons or indicators are always clearly displayed and the usability of the interface is improved.

Further, with the present invention, at least one button is displayed on the screen for controlling operation of the rotator, and the rotator is controlled when this button is operated by the input operating means. For example, if there is a plurality of types of control, buttons corresponding to each type of control are displayed on the screen, and the type of control of the rotator is performed corresponding to the operated button. This improves the operability of the rotator and the usability of the interface.

Further, with the present invention, the rotator is repeatedly rotated and paused, making operation easier for selecting an icon or indicator. The user can thus more easily determine the type and content of an icon or indicator and the usability of the interface improves because the operating time using the input operating means grows longer, thereby improving the operability.

With the interface according to the present invention, each icon or indicator can be viewed in order without any special operation because each icon or indicator is repeatedly displayed in sequence in the display area by moving at least one icon or indicator across the display area on the screen, and the icons or indicators displayed in the display area are selectively pointed by the input operating means.

Icons or indicators are clearly visible and the operation of selecting an icon or indicator is easy even on small screens because the icons or indicators can be displayed in sequence.

Further, since only a plurality of icons is repeatedly displayed in sequence in the display area, program processing can be significantly cut and the load on a computer reduced compared to the display of the rotator interface described above.

Further, with the present invention, movement of icons or indicators across the display area is performed intermittently, improving visibility and operability of the icons or indicators, thereby improving the usability of the interface.

With the present invention, a plurality of icons or indicators lined up in one direction can be viewed simultaneously because a plurality of icons or indicators are lined up in one direction in the display area and the icons or indicators are moved in that direction across the display area.

Further, with the present invention, a plurality of icons or indicators lined up in one direction can be viewed simultaneously and the display period of all the icons or indicators is shortened because a plurality of icons or indicators are lined up in one direction in the display area and the icons or indicators are moved across the display area in synchronization in another direction that intersects with the one direction.

For example, the plurality of icons or indicators displayed lined up in one direction in the display area is made up of icons or indicators and other icons or indicators which belong to these icons or indicators. Alternatively, the plurality of icons or indicators displayed lined up in one direction in the display area is icons or indicators which correspond to a plurality of functions which belongs to the same function group. In this case, a plurality of icons or indicators which are interrelated can be viewed systematically and simultaneously, making the differences between the functions corresponding to each icon or indicator clearer and easier to understand.

Further, with the present invention, a plurality of icons or indicators are displayed in the display area in rows and columns and the icons or indicators are moved in synchronization along each row or column across the display area, differentiating the display status of one row or column from the display status of other rows or columns.

For example, the display status of one row or column pointed by a cursor on the screen is differentiated from the display status of other rows or columns. In this case, the visibility of one row or column is made especially good, making it possible to draw attention to the icons or indicators in this row or column. This avoids confusion and makes it easier to find the desired icon or indicator even if a plurality of icons or indicators are displayed lined up in rows or columns.

The display status of the rows or columns includes the display color or brightness of the row or column, the decoration of the row or column, and so on.

Further, with the present invention, when an instruction is given via the input operating means to enlarge or reduce the display area, the display area is enlarged or reduced in response to this instruction. This makes it possible to adjust the number of icons or indicators displayed in the display area.

With the interface according to the present invention, the functions may for example be functions for controlling a printer, and the interface may be used for controlling the printer. The icons or indicators are for setting the print layout of printed matter printed by the printer.

In recent-years the functions of printers have become more diverse, and even more functions are in demand. For this reason there exists a need to display and present all icons or indicators in an easy-to-understand manner due to the resulting high number of icons or indicators which indicate each function. If it were possible to repeatedly display icons or indicators in sequence on circumferential face of a rotator on a screen or in a display area on a screen and selectively point the icons or indicators, it would be possible to display and present in an easy-to-understand manner all the icons or indicators and to select one of them simply.

With the interface of the present invention, it is preferable to provide a function executing means for rapidly executing the functions corresponding to the icons or indicators pointed by the input operating means.

Further, the interface of the present invention is realized by executing the interface program according to the present invention on a computer.

### BRIEF DESCRIPTION OF DRAWINGS

FIG. 1 is a block diagram showing a first embodiment of an interface according to the present invention.

FIG. 2(a) and FIG. 2(b) are diagrams showing a cylinder body interface in the interface according to the first embodiment and another cylinder body interface related to the cylinder body interface.

FIG. 3 is a diagram illustrating an administration data table in the interface according to the first embodiment.

FIG. 4 is a diagram illustrating an icon data table in the interface according to the first embodiment.

FIG. 5 is a diagram illustrating a description data table in the interface according to the first embodiment.

FIG. 6 is a diagram showing an operation to stop the cylinder body interface.

FIG. 7 is a diagram showing a variation of the cylinder body interface.

FIG. 8(a) and FIG. 8(b) are diagrams showing an operation to selectively point an icon on the cylinder body interface and an example of enlarged display of the icon.

FIG. 9(a) and FIG. 9(b) are diagrams showing an operation to selectively point a button on the cylinder body interface and an example of display of description information.

FIG. 10 is a diagram showing a history information display window in the interface according to the first embodiment.

FIG. 11(a), FIG. 11(b) and FIG. 11(c) are diagrams showing a cylinder body interface, another cylinder body interface, and an example of display of description information.

FIG. 12(a) and FIG. 12(b) are diagrams illustrating an operation to move an icon on the circumferential face of the cylinder body interface.

FIG. 13(a) and FIG. 13(b) are diagrams showing each cylinder body interface for setting color tones in grades.

FIG. 14(a) and FIG. 14(b) are diagrams illustrating other variations of the cylinder body interface.

FIG. 15 is a block diagram showing a personal computer, a printer, and so on which make up the interface according to the first embodiment.

FIG. 16 is a flowchart showing an overview of the steps of processing by the interface according to the first embodiment.

FIG. 17 is a flowchart showing in detail the process of step S102 in FIG. 16.

FIG. 18 is a flowchart showing in detail the process of step S103 in FIG. 16.

FIG. 19(a), FIG. 19(b), and FIG. 19(c) are diagrams showing the display status of a display area in a second embodiment of the interface according to the present invention.

FIG. 20 is a diagram illustrating an administration data table in the interface according to the second embodiment.

FIG. 21 is a diagram illustrating an icon data table in the interface according to the second embodiment.

FIG. 22 is a diagram showing a variation of the display area according to the second embodiment.

FIG. 23 is a diagram showing another variation of the display area according to the second embodiment.

FIG. 24 is a diagram showing the display status of a main display area and a sub display area according to a third embodiment of the interface according to the present invention.

FIG. 25 is a diagram illustrating a representative icon data table in the interface according to the third embodiment.

FIG. 26 is a diagram illustrating a subsidiary icon data table in the interface according to the third embodiment.

FIG. 27 is a flowchart showing the steps in the process up until formation the main display area and the sub display area in the interface according to the third embodiment.

FIG. 28(a) and FIG. 28(b) are diagrams showing another display status of the main display area and the sub display area in the interface according to the third embodiment.

FIG. 29(a) and FIG. 29(b) are diagrams showing a different display status of the main display area and the sub display area in the interface according to the third embodiment.

FIG. 30 is a flowchart showing the steps in a process for implementing the display statuses in FIG. 29(a) and FIG. 29(b).

FIG. 31(a) and FIG. 31(b) are diagrams showing how the width of the sub display area in the interface according to the third embodiment changes.

FIG. 32 is a diagram illustrating icons in the interface according to an embodiment.

### DESCRIPTION OF THE PREFERRED EMBODIMENTS

Below follows a detailed description of embodiments of the present invention with reference to the accompanying figures.

### FIRST EMBODIMENT

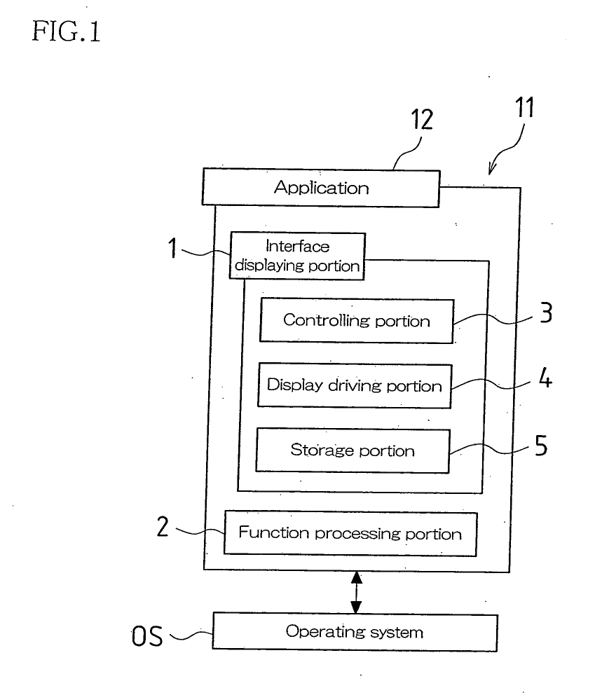

FIG. 1 is a block diagram showing a first embodiment of an interface according to the present invention. An interface 11 according to the present embodiment executes an application software 12 for the interface 11 on the basis of an operating system OS of a personal computer, for example, and is made up by operating a liquid display device or other type of display device, a mouse or other type of pointing device, and peripheral devices such as a printer.

The application software 12 includes an interface displaying portion 1 and a function processing portion 2. The interface displaying portion 1 includes a controlling portion 3 for controlling a cylinder body interface UI displayed on the screen of a display device, a display driving portion 4 for operating the cylinder body interface UI on the screen in response to instructions from the controlling portion 3, and a storage portion 5 for performing storage control of various types of information necessary for displaying the cylinder body interface UI.

The function processing portion 2 controls the entire application software 12. For example, it receives an event from a peripheral device via the operating system OS, sends this event to the controlling portion 3 of the interface displaying portion 1, receives information from the controlling portion 3, and sends this information to the peripheral device via the operating system OS.

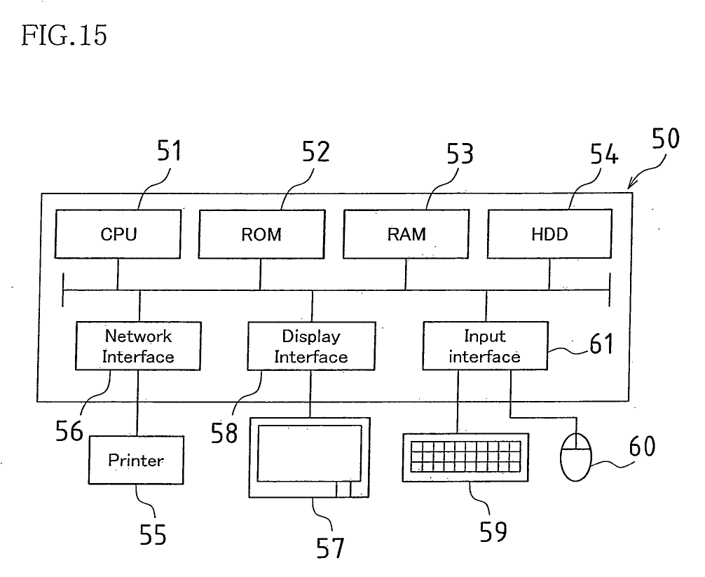

FIG. 15 is a block diagram showing a personal computer, a printer, and so on which make up the interface 11. A computer unit 50 is provided with a CPU (central processing unit) 51 for centrally controlling the computer unit 50, a ROM 52 for storing various types of programs and data, a RAM 53 for temporarily storing various types of data and being used as a work area, a hard disk drive (HDD) 54 for storing various types of programs and data, a network interface portion 56 which is connected to a printer 55 via a network, a display interface portion 58 which is connected to a display device 57, an input interface portion 61 which is connected to a keyboard 59 and a pointing device (for example, a mouse) 60, and so on.

The CPU 51 reads the operating system OS, the application software 12, and so on from the hard disk drive 54, executes the application software 12 on the basis of the operating system OS as described above, and controls the printer 55 via the network interface portion 56, controls display of the display device 57 via the display interface portion 58, and inputs data and instructions from the keyboard 59, mouse 60 and the like via the input interface portion 61, thus creating the interface 11. Accordingly, the CPU 51 is for realizing the functions of the operating system OS, the application software 12 and the like.

Next follows a description of operation of the interface 11 according to the present embodiment based on the software configuration shown in FIG. 1.

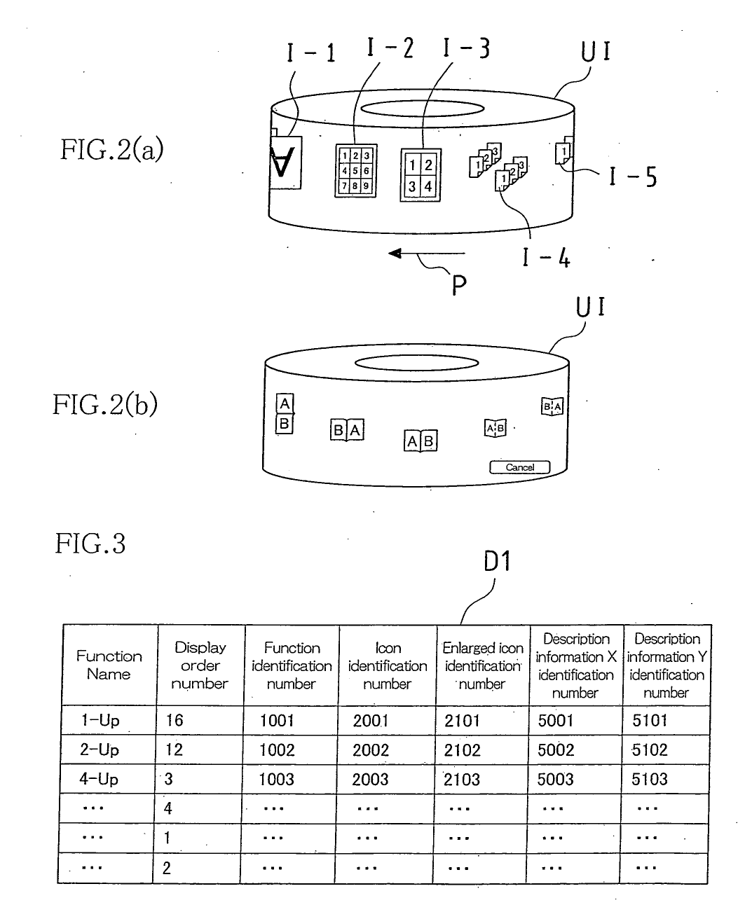

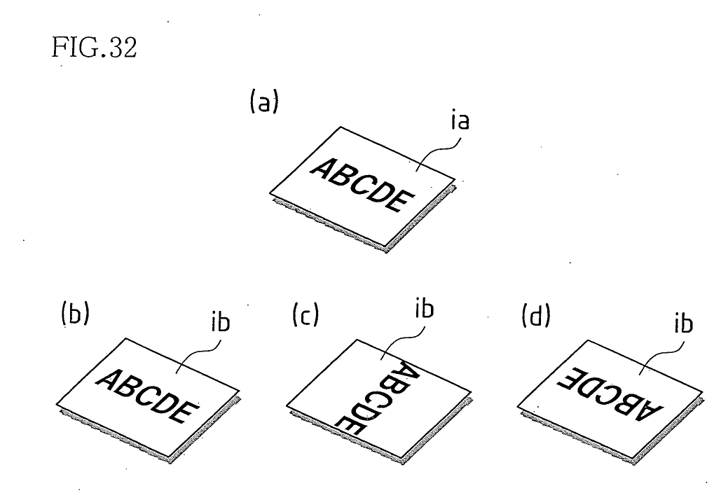

Here, the cylinder body interface UI which is displayed on the screen of the display device 57 by the interface displaying portion 1 is similar to that shown in, for example, FIG. 2(a) and rotates in the direction of the arrow P on the screen. The cylinder body interface UI displays a plurality of icons I-1 through I-n arranged on the circumferential face and displays the icons I-1 through I-n in sequence on the screen as the cylinder body interface UI rotates in the direction of the arrow P. The icons placed on the cylinder body interface UI schematically illustrate functions and may be still images or moving images. As an example of a still-image icon, there is an icon ia shown in FIG. 32(a), and as an example of a moving-image icon, there is an icon ib in which the character string “ABCDE” rotates as shown in FIG. 32(b) through FIG. 32(d).

To control display of the cylinder body interface UI, in the interface displaying portion 1 the controlling portion 3 reads various types of information in the hard disk drive 54 via the storage portion 5, setting the content displayed on the circumferential face of the cylinder body interface UI based on that information, receiving events from peripheral devices via the operating system OS and the function processing portion 2, determining the operation of the cylinder body interface UI in response to these events, and instructing this display content and operations to the display driving portion 4. The display driving portion 4 controls drive of the display device 57 via the function processing portion 2 and the operating system OS in response to instructions from the controlling portion 3, displaying the icons I-1 through I-n arranged on the circumferential face of the cylinder body interface UI on the screen of the display device 57 and rotating the cylinder body interface UI.

For example, if the application software 12 is a driver for controlling the printer 55, then the cylinder body interface UI for controlling the printer is displayed on the screen of the display device.

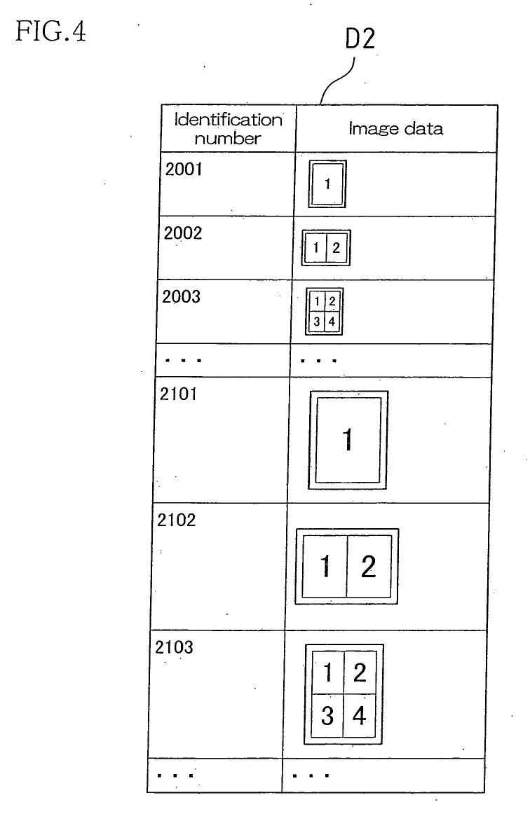

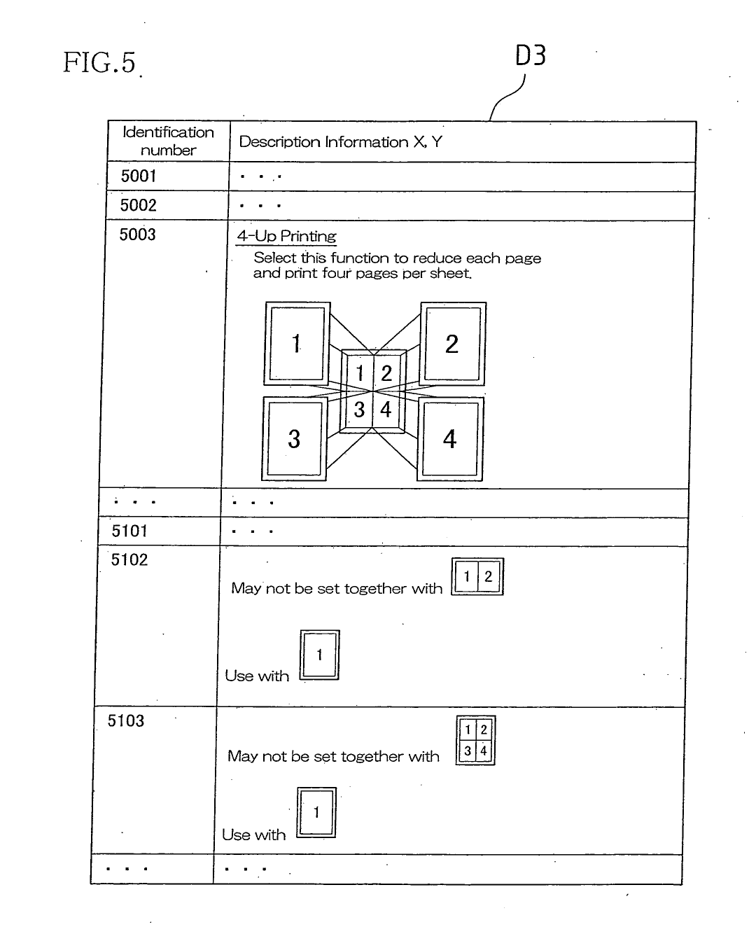

In this case, an administration data table D1 as shown in FIG. 3, an icon data table D2 as shown in FIG. 4, and a description data table D3 as shown in FIG. 5 need to be stored ahead of time in the hard disk drive 54 as various types of information.

The administration data table D1 in FIG. 3 stores information related to the icons I-1 through I-n placed on the circumferential face of the cylinder body interface UI for controlling the printer. For example, the function names corresponding to the icons I-1 through I-n, the display order of the icons I-1 through I-n on the circumferential face of the cylinder body interface UI, the identification numbers of each function, the identification numbers of each of the icons I-1 through I-n, the identification number of the enlarged icons J-1 through J-n which are enlarged displays of the icons I-1 through I-n, the identification numbers of the description information X related to each function, and the identification numbers of the description information Y related to each function, all cross-referenced.

The icon data table D2 in FIG. 4 stores the identification numbers of the icons I-1 through I-n and the image data of each icon, all cross-referenced, together with the identification numbers of the enlarged icons J-1 through J-n and the image data of each enlarged icon, all cross-referenced.

For example, image data for the icons corresponding to icon identification numbers 2001 through 2003 and image data for the enlarged icons corresponding to enlarged icon identification numbers 2101 through 2103 are stored.

Further, the description data table D3 in FIG. 5 stores the identification numbers for the description information X related to each function and each description information X, all cross-referenced, and also stores the identification numbers for the description information Y related to each function and each description information Y, all cross-referenced. For example, the description information X corresponding to the description information X identifications numbers 5001 through 5003 and the description information Y corresponding to the description information Y identifications numbers 5101 through 5103 are stored.

Further, the administration data table D1, the icon data table D2 and the description data table D3 are for displaying the cylinder body interface UI used for setting page layout. Other data tables D1, D2, and D3 which are stored in the hard disk drive 54 and are used for selectively displaying various cylinder body interfaces UI include data tables for displaying a cylinder body interface UI used for setting the binding of pages, data tables for displaying a cylinder body interface UI used for setting the color tone in color printing, data tables for displaying a cylinder body interface UI used for setting text formats, and so on.

Next, a more detailed description is provided of the cylinder body interface UI for controlling a printer.

First, when the application software 12 is launched, the controlling portion 3 references the administration data table D1 and the icon data table D2 in the hard disk drive 54 via the storage portion 5 and reads from the administration data table D1 the display order and the identification numbers of the icons I-1 through I-n and then reads from the icon data table D2 the image data corresponding to the identification numbers of the icons I-1 through I-n. The controlling portion 3 then gives the display order, the identification numbers, and the image data of the icons I-1 through I-n to the display driving portion 4. The display driving portion 4 then controls the drive of the display device 57 via the function processing portion 2- and the operating system OS and then on the screen of the display device 57 arranges the icons I-1 through I-n displayed according to the image data shown in FIG. 2(a) around the circumferential face of the cylinder body interface UI in the display order of each icon, and rotates the cylinder body interface UI in the direction of the arrow P. At this time, the controlling portion 3 monitors the display status of the cylinder body interface UI on the screen via the display driving portion 4.

In this status, the user can sequentially view the icons I-1 through I-n as the cylinder body interface UI rotates. Each icon is clearly visible even on a small screen, as the icons I-1 through I-n can be placed separated from one another on the circumferential face of the cylinder body interface UI.

Further, if the circumferential face of the cylinder body interface UI are virtually set to be long enough, it is possible to place more icons on the circumferential face of the cylinder body interface UI, making it possible to present all the icons and providing the opportunity to use the functions corresponding to those icons.

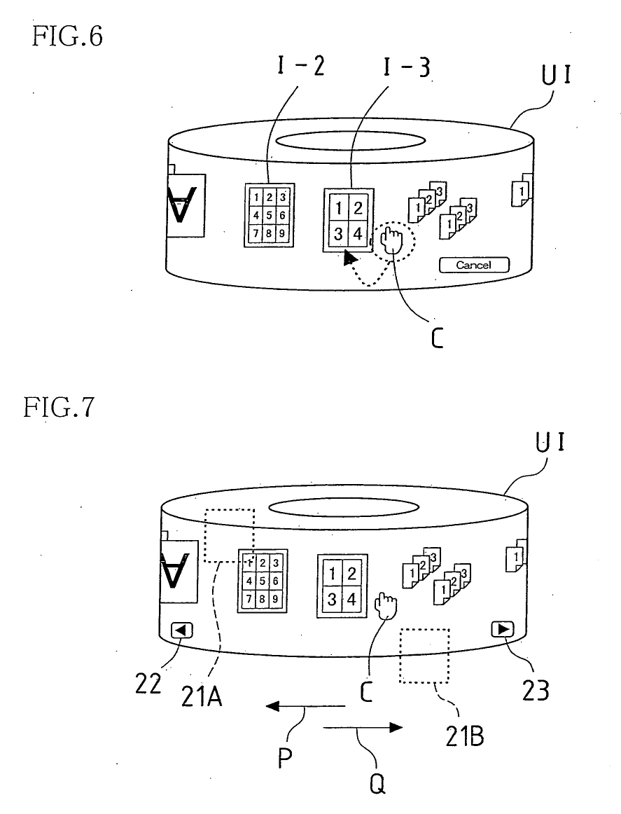

As the cylinder body interface UI rotates, the user operates the mouse or other pointing device 60 moving a cursor C on the screen as shown in FIG. 6 so that it is placed over the cylinder body interface UI. When this happens, the controlling portion 3 receives the position of the cursor C via the operating system OS and the function processing portion 2, determines that the position is over the cylinder body interface UI, and gives the display driving portion 4 an instruction to stop the cylinder body interface UI. The display driving portion 4 stops the rotation of the cylinder body interface UI in response to the stop instruction.

With the cylinder body interface UI stopped, the user can operate the pointing device 60, moving the cursor C on the screen in FIG. 6 over any of the icons on the circumferential face of the cylinder body interface UI, and perform a clicking operation with the pointing device 60 to select and point the desired icon.

Further, if the cursor C is moved outside the cylinder body interface UI, the rotation of the cylinder body interface UI restarts. Instead of moving the cursor C over the cylinder body interface UI, it is possible also to perform a clicking operation with the pointing device 60. In this case, the controlling portion 3 receives the clicking operation via the operating system OS and the function processing portion 2 and gives the display driving portion 4 an instruction to stop the cylinder body interface UI in response to this clicking operation. The display driving portion 4 stops the rotation of the cylinder body interface UI in response to the stop instruction. When another clicking operation is performed, the rotation of the cylinder body interface UI restarts.

It is also possible to instruct to change the speed of rotation or the direction of rotation of the cylinder body interface UI in response to movement of the cursor C or clicking operations by the pointing device 60. For example, if the cursor C is moved to an icon non-display region 21A on the side of the rotation of the cylinder body interface UI as shown in FIG. 7 and the pointing device 60 is clicked, in response the controlling portion 3 receives the position of the cursor C and the clicking operation via the operating system OS and the function processing portion 2, determines that the position is over the icon non-display region 21A and deems that the click operation is pointing the icon non-display region 21A, and instructs the display driving portion 4 to reduce the speed of rotation of the cylinder body interface UI. In response, the display driving portion 4 reduces the speed of rotation of the cylinder body interface UI on the screen. Alternately a button 22 in FIG. 7 may be displayed on the side of rotation of the cylinder body interface UI and when the cursor C is moved to the button 22 and a clicking operation is performed with the pointing device 60, in response the controlling portion 3 gives an instruction for the speed of rotation of the cylinder body interface UI to be reduced, and the display driving portion 4 reduces the speed of rotation of the cylinder body interface UI on the screen. Identification of each icon on the circumferential face of the cylinder body interface UI is thus made extremely simple.

When the cursor C is moved to the icon non-display region 21A or the button 22 and a double-clicking operation is performed with the pointing device 60, in response the controlling portion 3 gives an instruction to raise the speed of rotation of the cylinder body interface UI and the display driving portion 4 raises the speed of rotation of the cylinder body interface. UI on the screen. This makes it possible to see each icon on the circumferential face of the cylinder body interface UI in a short time.

Further, when the cursor C is moved to the icon non-display region 21B on the opposite side of the direction of rotation of the cylinder body interface UI in FIG. 7 and a clicking operation is performed with the pointing device 60, in response the controlling portion 3 gives an instruction to rotate in the direction of the arrow Q and reduce the speed of rotation, and the display driving portion 4 rotates the cylinder body interface UI in the direction of the arrow Q and reduces the speed of rotation on the screen. Alternately, a button 23 in FIG. 7 may be displayed on the opposite side of the rotation of the cylinder body interface UI and when the cursor C is moved to the button 23 and a clicking operation is performed with the pointing device 60, in response the controlling portion 3 gives an instruction to rotate in the direction of the arrow Q and reduce the speed of rotation, and the display driving portion 4 rotates the cylinder body interface UI in the direction of the arrow Q and reduces the speed of rotation on the screen. This makes it possible to immediately return and view an icon on the circumferential face of the cylinder body interface UI which has passed by.

When the cursor C is moved to the non-display region 21B or the button 23 and a double-clicking operation is performed with the pointing device 60, in response the controlling portion 3 gives an instruction to rotate in the direction of the arrow Q and raise the speed of rotation and the display driving portion 4 rotates the cylinder body interface UI in the direction of the arrow Q and raises the speed of rotation of the cylinder body interface UI. This makes it possible to see each icon on the circumferential face of the cylinder body interface UI in a short time.

As the cylinder body interface. UI rotates either in the direction of the arrow P or the arrow Q, the user moves the cursor C over any of the icons on the circumferential face of the cylinder body interface UI and performs a clicking operation with the pointing device 60 to select and point the desired icon.

It can be performed easily to select and point the icon if the speed of rotation of the cylinder body interface UI is reduced.

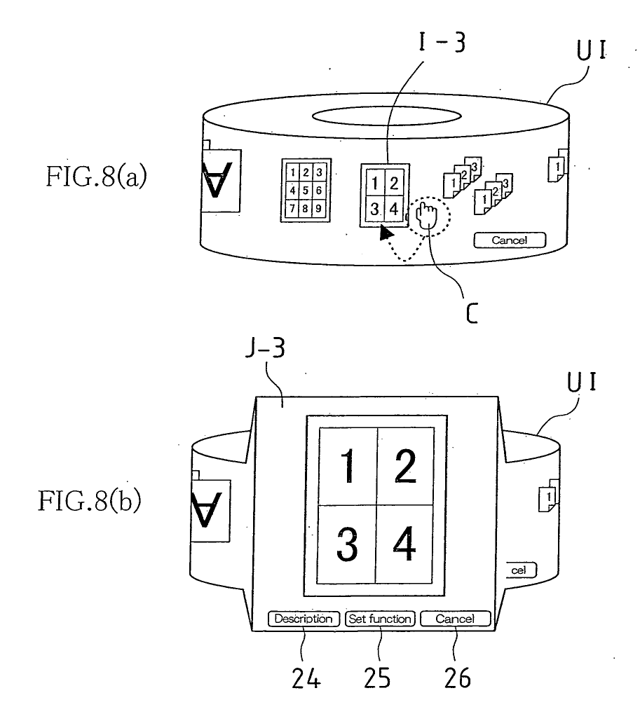

Next, if for example the desired icon I-3 on the circumferential face of the cylinder body interface UI is selected and pointed through operation of the pointing device 60 as shown in FIG. 8(a), the controlling portion 3 receives the position of the icon I-3 from the operating system OS and the function processing portion 2, and determines that the icon I-3 at that position has been selected and pointed, and stores the identification number of the icon I-3 to the RAM 53 via the storage portion 5. The controlling portion 3 then reads the image data for the enlarged icon J-3 corresponding to that identification number from the icon data table D2 and passes the image data for the enlarged icon J-3 to the display driving portion 4. The display driving portion 4 controls driving of the display device 57 via the function processing portion 2 and the operating system OS and displays the enlarged icon J-3 which is shown by the image data shown in FIG. 8(b) on the screen of the display device 57. When this happens, the display driving portion 4 displays a description button 24, a function setting button 25, a cancel button 26, and so on, together with the enlarged icon J-3.

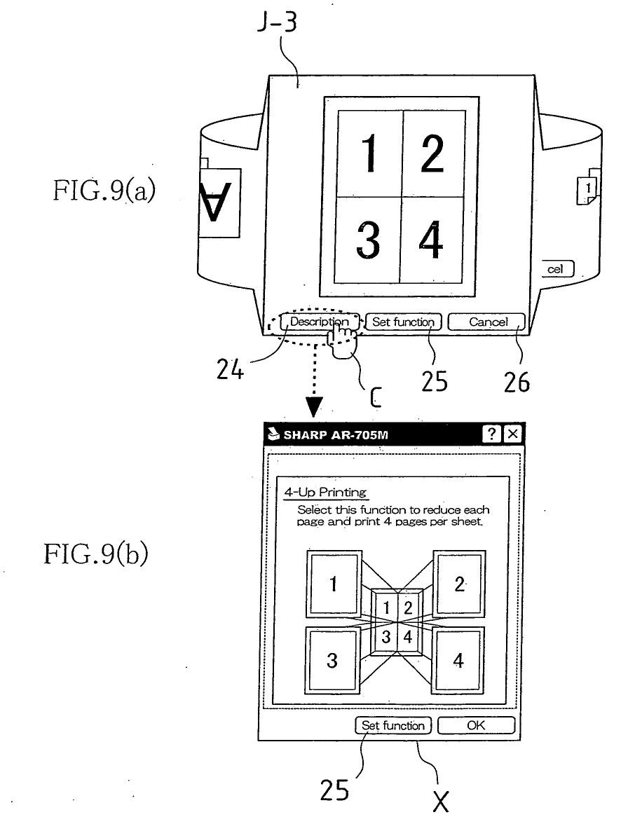

The user can now clearly identify the enlarged icon J-3. The user can further operate the pointing device 60, moving the cursor C on the screen as shown for example in FIG. 9(a) over the description button 24 and perform a clicking operation with the pointing device 60 to request a description of the function corresponding to the enlarged icon J-3. When this happens, the controlling portion 3 receives the position of the cursor C and the clicking operation via the operating system OS and the function processing portion 2 and determines that this position overlaps with the description button 24 and deems that the clicking operation is pointing the description button 24, and then reads from the administration data table D1 the identification number of the description information X which corresponds to the identification number of the enlarged icon J-3, and then reads from the description data table D3 the description information X which corresponds to the identification number which was read, and instructs the display driving portion 4 to display the description information X which was read. In response the display driving portion 4 displays the description information X on the screen as shown in FIG. 9(b).

Alternately, if the cursor C is moved over the cancel button 26 in FIG. 9(a) and a clicking operation is performed with the pointing device 60, in response the controlling portion 3 cancels the setting of the function which corresponds to the enlarged icon J-3, erases via the storage portion 5 the identification number of the icon I-3 from the RAM 53 which was stored previously, and instructs the display driving portion 4 to return to the screen in FIG. 8(a).

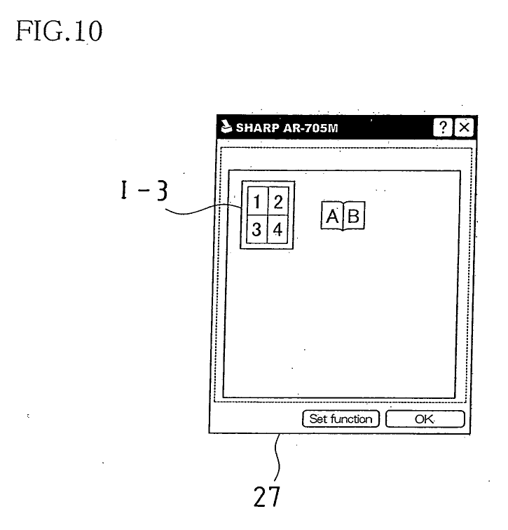

If the cursor C is moved to the function setting button 25 in FIG. 9(a) or FIG. 9(b) and a clicking operation is performed using the pointing device 60, in response the controlling portion 3 sets the function corresponding to the enlarged icon J-3. The controlling portion 3 then instructs the display driving portion 4 to display the icon I-3 of the function which was set. The display driving portion 4 controls driving of the display device via the function processing portion 2 and the operating system OS to display on the screen of the display device a history information display window 27 as shown in FIG. 10 and display the icon I-3 of the function which was set in the history information display window 27.

Further, when a function corresponding to an icon on the circumferential face of the cylinder body interface UI of FIG. 2(a) is set, the interface displaying portion 1 determines whether or not there exist other functions related to the set function, and if no related functions exist, it returns to the display of the cylinder body interface UI in FIG. 2(a), but if related functions do exist, it references the other administration data table D1, the other icon data table D2, and the other description data table D3 in the hard disk drive 54 which stores various types of information related to the icons of the other functions, just like the cylinder body interface UI of FIG. 2(a) and displays, for example, the other cylinder body interface UI of FIG. 2(b) on the screen, in order to encourage setting of those other functions, thereby supporting input and setting of functions which correspond to other icons on the circumferential face of the other cylinder body interface UI.

Here, the icons on the circumferential face of the cylinder body interface UI in FIG. 2(a) are used to set the page layout, while the icons on the circumferential face of the other cylinder body interface UI in FIG. 2(b) are used to set the page binding. Accordingly, the cylinder body interface UI in FIG. 2(a) is used to set the page layout and the other cylinder body interface UI in FIG. 2(b) is used to set the page binding.

Similarly, thereafter whenever a function corresponding to an icon on the circumferential face of the cylinder body interface UI is set, if there are other functions related to the set function, then other cylinder body interface UI for setting those functions is displayed on the screen, supporting input and setting of functions which correspond to icons on the circumferential face of the other cylinder body interface UI. Every time each cylinder body interface UI is displayed in sequence on the screen and functions on them are set, a list of icons of functions which have been set is displayed in the history information display window 27 in FIG. 10.

The hard disk drive 54 stores ahead of time associated information for each of the functions which are set using the plurality of cylinder body interfaces UI. Therefore when the controlling portion 3 sets a function on the cylinder body interface UI, referencing the associated information in the hard disk drive 54 via the storage portion 5, it is possible to display other cylinder body interfaces UI for setting other functions which are associated with this function.

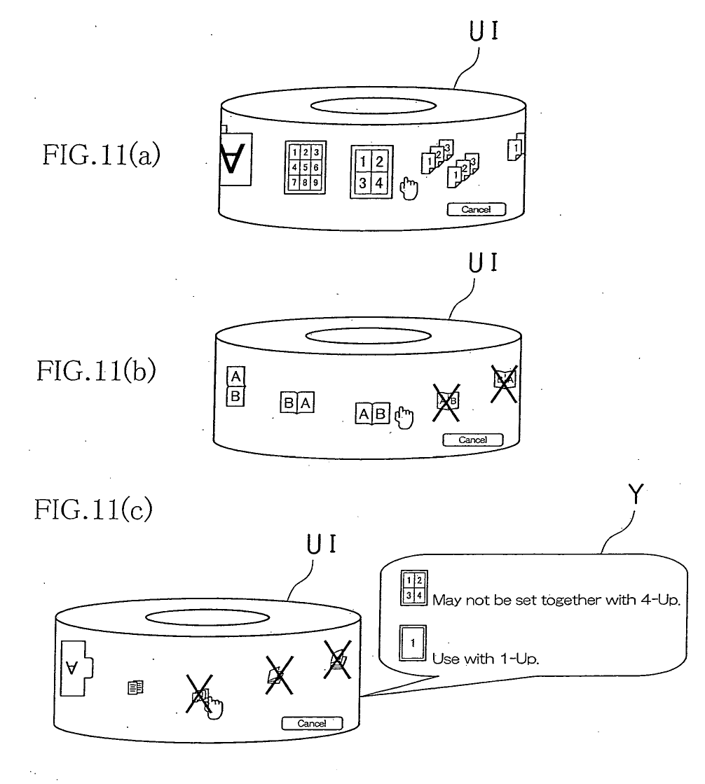

Depending on the function set using the cylinder body interface UI, if the function to be set next using another cylinder body interface UI is limited, the display of the circumferential face of the other cylinder body interface UI reflects the content of this limitation. For example, in the case that a function has already been set which corresponds to one icon on the circumferential face of the cylinder body interface UI as shown in FIG. 11(a), and then another function is set using another cylinder body interface UI as shown in FIG. 11(b), an x symbol is placed on every icon on the circumferential face of the other cylinder body interface UI which cannot be set or whose setting is suppressed due to the function which was already set. This makes it possible to avoid selecting functions which correspond to icons which cannot be set or whose setting is suppressed and avoid wastefull inputting.

Further, when the cursor C is moved to an icon on which an x symbol is placed on the circumferential face of the other cylinder body interface UI in FIG. 11(b) and a clicking operation is performed with the pointing device 60, the controlling portion 3 reads from the administration data table D1 the identification number for the description information Y which corresponds to the identification number of the icon on which an x symbol is placed and then reads from the description data table D3 the description information Y which corresponds to the read identification number, and instructs the display driving portion 4 to display the read description information Y. In response the display driving portion 4 displays the description information Y on the screen as shown in FIG. 11(c). With the display of the description information Y, the reason is shown for which the function which corresponds to the icon on which an x symbol is placed cannot be set or for which the setting is suppressed.

When an instruction is given to begin printing by operating the pointing device 60 after all the icons for all the necessary functions are displayed in the history information display window 27 in FIG. 10, this instruction is sent to the controlling portion 3 via the operating system OS and the function processing portion 2, and in response the application software 12 controls the printer 55 via the function processing portion 2 and the operating system OS, and printing is performed using the functions which correspond to the icons in the history information display window 27 in FIG. 10.

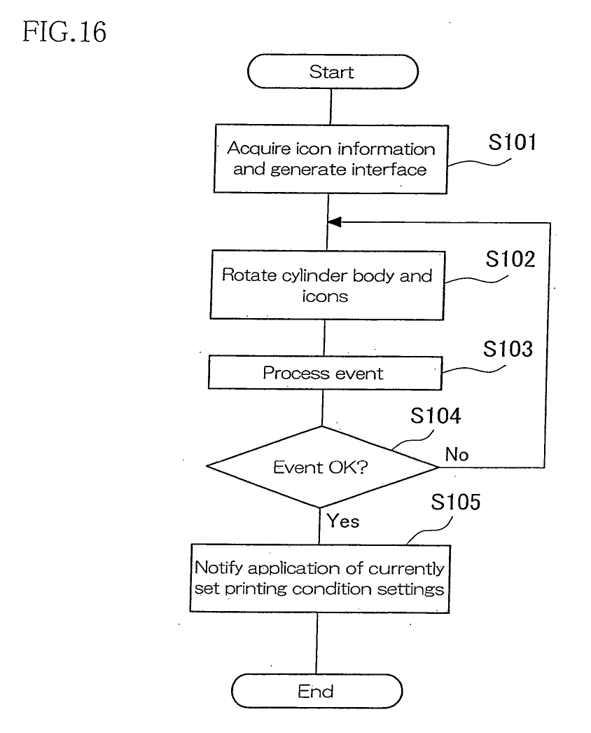

Next, an overview is given of the steps in the process by the interface 11 according to the present embodiment as described above, with reference to the flowchart in FIG. 16.

First, the controlling portion 3 references the administration data table D1 and the icon data table D2 in the hard disk drive 54 via the storage portion 5 and reads and provides to the display driving portion 4 the display order and the identification numbers of the icons I-1 through I-n and the image data corresponding to the identification numbers of the icons I-1 through I-n. The display driving portion 4 then controls the drive of the display device 57 via the function processing portion 2 and the operating system OS and then on the screen of the display device 57, as shown in FIG. 2(a), arranges the icons I-1 through I-n displayed according to the image data around the circumferential face of the cylinder body interface UI in the display order of each icon, and generates the cylinder body interface UI (step s101).

Next, the display driving portion 4 rotates the cylinder body interface UI in the direction of the arrow P. When this happens, the controlling portion 3 receives the position of the cursor C on the screen via the operating system OS and the function processing portion 2 and performs control such as rotating and stopping the cylinder body interface UI based on the position of the cursor C (step S102).

Further, based on the position of the cursor C on the screen, the controlling portion 3 performs as needed event processes such as selectively pointing icons on circumferential face of the cylinder body interface UI, pointing description buttons, deleting enlarged icons and description information, setting functions which correspond to enlarged icons, and so on (step S103). If no instruction is given to terminate the cylinder body interface UI (“No” at step S104), then the process returns to step S102. If an instruction is given to terminate the cylinder body interface UI (“Yes” at step S104), the controlling portion 3 terminates the processing of the interface displaying portion 1 after passing through step S105.

If another cylinder body interface UI is to be displayed in step S103, then the process returns to step S101.

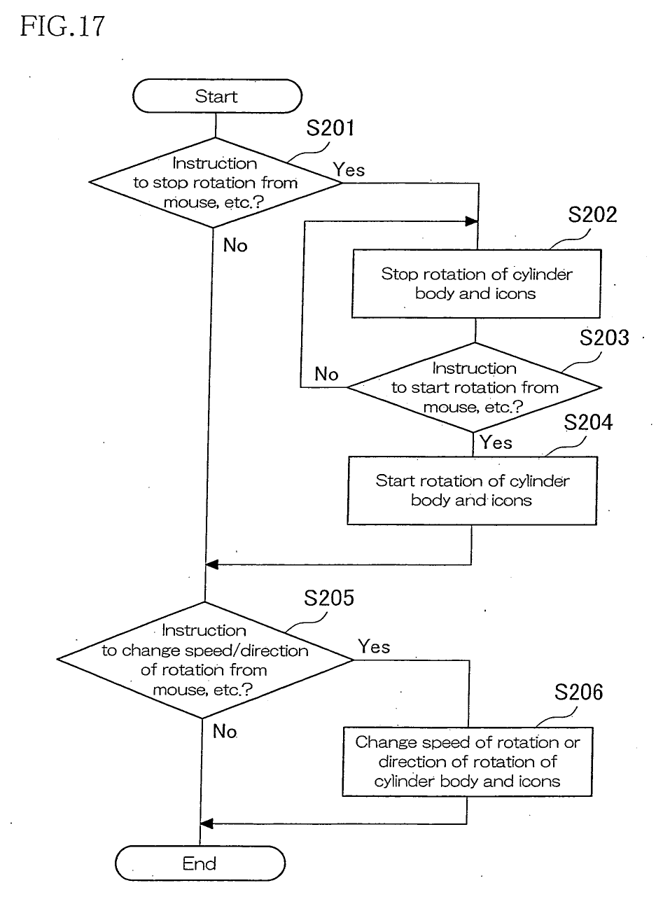

FIG. 17 is a flowchart showing in detail the process of step S102 in FIG. 16. A description is now given of the process of rotating or stopping the cylinder body interface UI and the process of changing the direction of rotation or the speed of rotation described above, with reference to the flowchart.

Here, the controlling portion 3 determines whether or not the position of the cursor C overlaps with the cylinder body interface UI in FIG. 6 (step S201). If the position of the cursor C does not overlap with the cylinder body interface UI (“No” at step S201), then this process is terminated with the rotation of the cylinder body interface UI maintained. The controlling portion 3 then determines whether the cursor C moves to either of the icon non-display regions 21A, 21B or the buttons 22, 23 of the cylinder body interface UI in FIG. 7 and a clicking operation or a double-clicking operation is performed with the pointing device 60 (step S205), and if the determination is “No” (“No” at step S205), the process is terminated with the rotation of the cylinder body interface. UI maintained.

If the cursor C overlaps with the cylinder body interface UI (“Yes” at step S201), the controlling portion 3 stops the rotation of the cylinder body interface UI via the display driving portion 4 (step S202). The controlling portion 3 then maintains the stoppage of the cylinder body interface UI as long as the position of the cursor C overlaps with the cylinder body interface UI (“No” at step S203), but restarts the rotation of the cylinder body interface UI (step S204) once the position of the cursor C moves off of the cylinder body interface UI (“Yes” at step S203).

If the controlling portion 3 determines that the cursor C is moved to either the icon non-display regions 21A, 21B or the buttons 22, 23 and a clicking operation or a double-clicking operation is performed (“Yes” at step S205), it changes the direction of rotation or the speed of rotation of the cylinder body interface UI depending on which of the icon non-display regions 21A, 21B and the buttons 22, 23 the cursor C overlaps with and the type of clicking operation (step S206).

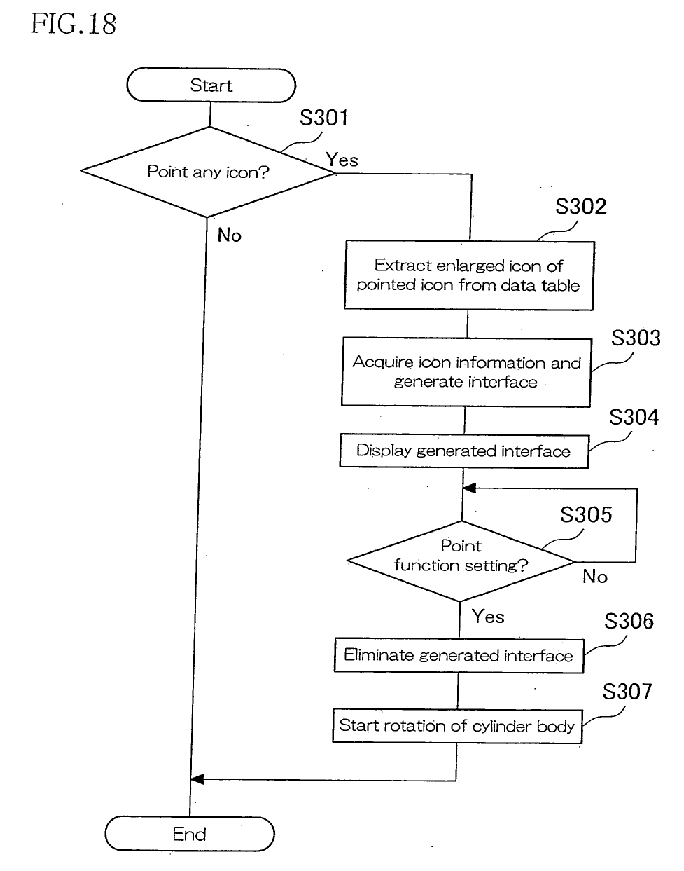

FIG. 18 is a flowchart showing in detail the process of step S103 in FIG. 16. A description is now given of event processes for icons on circumferential face of the cylinder body interface UI such as selectively pointing icons, pointing description buttons, deleting enlarged icons and description information, setting functions which correspond to enlarged icons, and so on, as described above, with reference to the flowchart.

First, when the cursor C overlaps with and points any of the icons of the cylinder body interface UI (step S301), the controlling portion 3 reads from the icon data table D2 the enlarged icon image data corresponding to the identification number of that icon (step S302), and displays for example the enlarged icon as shown in FIG. 8(b) on the screen of the display device 57 via the display driving portion 4 (steps S303 and S304).

When this happens, the description button 24, the function setting button 25, the cancel button 26, and so on, are displayed together with the enlarged icon. If the cursor C is placed over the description button 24 and a clicking operation is performed with the pointing device 60, the controlling portion 3 reads from the administration data table D1 the identification number of the description information X which corresponds to the identification number of the enlarged icon, and then reads from the description data table D3 the description information X which corresponds to the identification number which was read, and displays on the screen of the display device 57 the read description information X via the display driving portion 4. Alternatively, if the cursor C is placed over the cancel button 26 and a clicking operation is performed with the pointing device 60, setting of the function corresponding to the enlarged icon is canceled, the original cylinder body interface UI is displayed, and the process returns to step S301.

Next, with the enlarged icon displayed, the controlling portion 3 waits for a function setting to be pointed (“No” at step S305), and, when the cursor C is placed over the function setting button 25, a clicking operation is performed with the pointing device 60, and the function setting is pointed (“Yes” at step S305), deletes the enlarged icon via the display driving portion 4 (step 306) and moves to step S104. The controlling portion 3 then determines whether or not there exist other functions related to the pointed function, and displays the original cylinder body interface UI if other related functions do not exist, and returns to step S101 in order to display a different cylinder body interface UI for setting other functions if other related functions do exist (step S307).

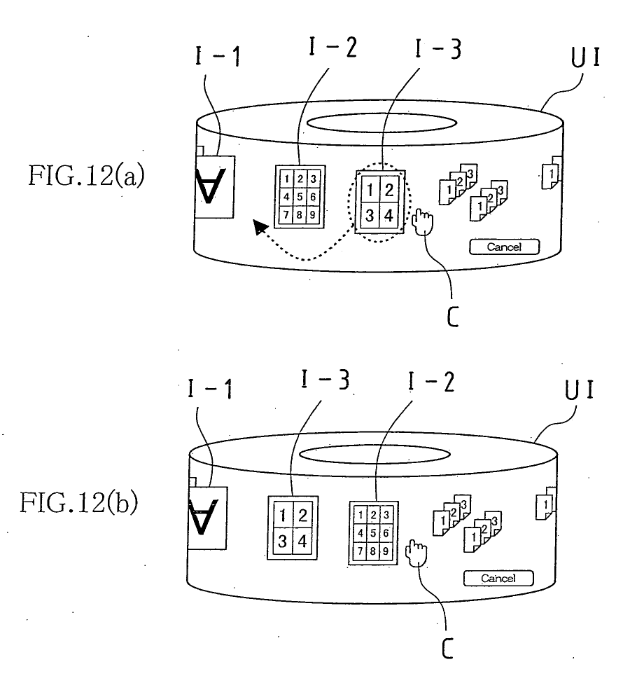

Incidentally, it is possible to change the display order of the icons on the circumferential face of the cylinder body interface UI. For example, as shown in FIG. 12(a) and FIG. 12(b), the desired icon I-3 on the circumferential face of the cylinder body interface UI is selected and moved by operating the pointing device 60. When this happens, the controlling portion 3 receives the position of the destination of the icon I-3 via the operating system OS and the function processing portion 2, obtains the display order for each icon on the circumferential face of the cylinder body interface UI corresponding to the position of the destination of the icon I-3, and via the storage portion 5 updates the display order of the icons in the administration data table in the hard disk drive 54 to the obtained display order. The display order of the icons on the circumferential face of the cylinder body interface UI is thereby changed.

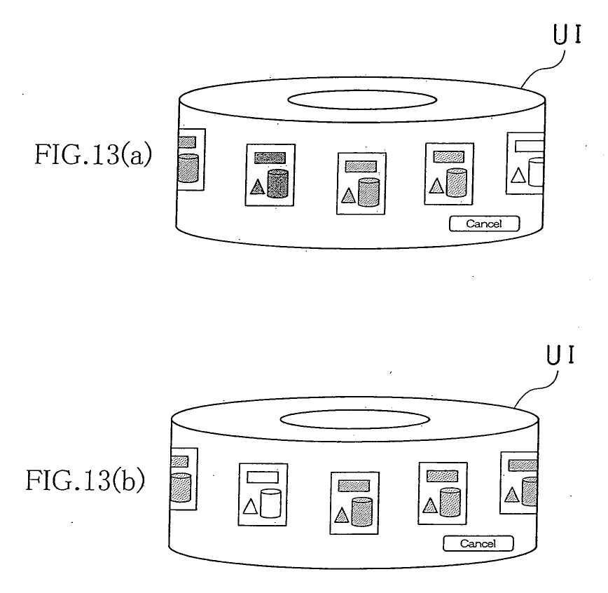

When a cylinder body interface UI is displayed which is used for setting color tones for color printing, the cylinder body interfaces UI as shown in FIG. 13(a) and FIG. 13(b) may be displayed in sequence, and the color tones set in stages. In other words, the cylinder body interface UI in FIG. 13(a) is displayed, one of the broad color tones corresponding to the icons on the circumferential face of the cylinder body interface UI is selected and set, and then the cylinder body interface UI in FIG. 13(b) is displayed, and a fine color tone corresponding to one of the icons on the circumferential face of the cylinder body interface UI—in other words, a finer gradation of the broad color tone set previously—is selected and set.

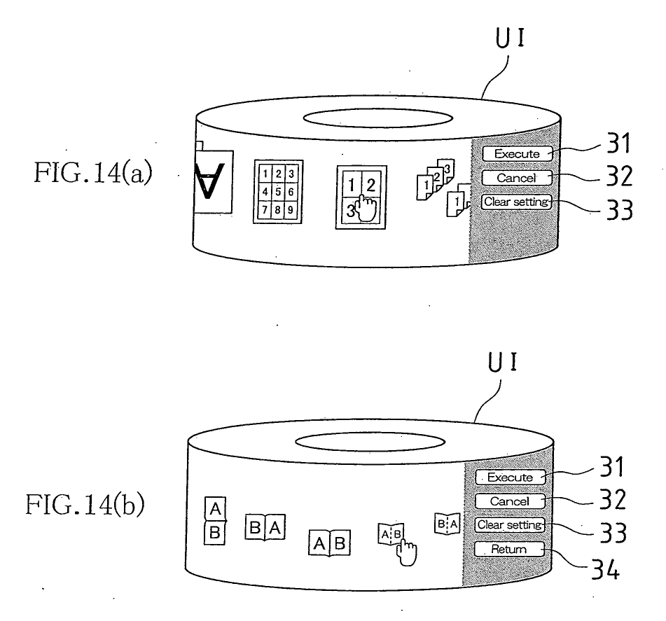

Further, as shown in FIG. 14(a) and FIG. 14(b), an execute button 31, a cancel button 32, a clear setting button 33, and a return button 34, etc., are displayed on part of the cylinder body interface UI, and when any of the buttons 31 through 34 is selectively pointed, a process corresponding to the selectively pointed button may be performed.

An example is given in which the application software 12 is a driver for controlling the printer 55, but application software for performing other controls or processes is also possible. For example, it may be a driver for controlling a display device. In this case, icons corresponding to the contrast, brightness, and color tone, etc., of a screen on a display device could be displayed arranged on the circumferential face of the cylinder body interface UI, and one of those icons could be selectively pointed.

Further, if there is no cursor C used by a pointing device 60 on the cylinder body interface UI, then a timer could be set by the controlling portion 3, and the rotation of the cylinder body interface UI could be stopped for a set amount of time for each icon, and once the timer stops, the rotation of the cylinder body interface UI could restart, and this process could be repeated.

The display of the enlarged icons and the description information could be omitted. In this case, when the cursor C is placed over an icon on the circumferential face of the cylinder body interface UI and a clicking operation is performed, the icon is displayed in the history information display window 27 and the function corresponding to the icon is immediately set.

Further, a polygonal tube or other shapes may be used in lieu of a cylinder body.

### SECOND EMBODIMENT

Next, a second embodiment of the interface according to the present invention will be described.

The interface according to the present embodiment is configured in a similar fashion to the interface 11 of FIG. 1. The personal computer, printer, and so on which make up the interface 11 are also identical to those shown in FIG. 15.

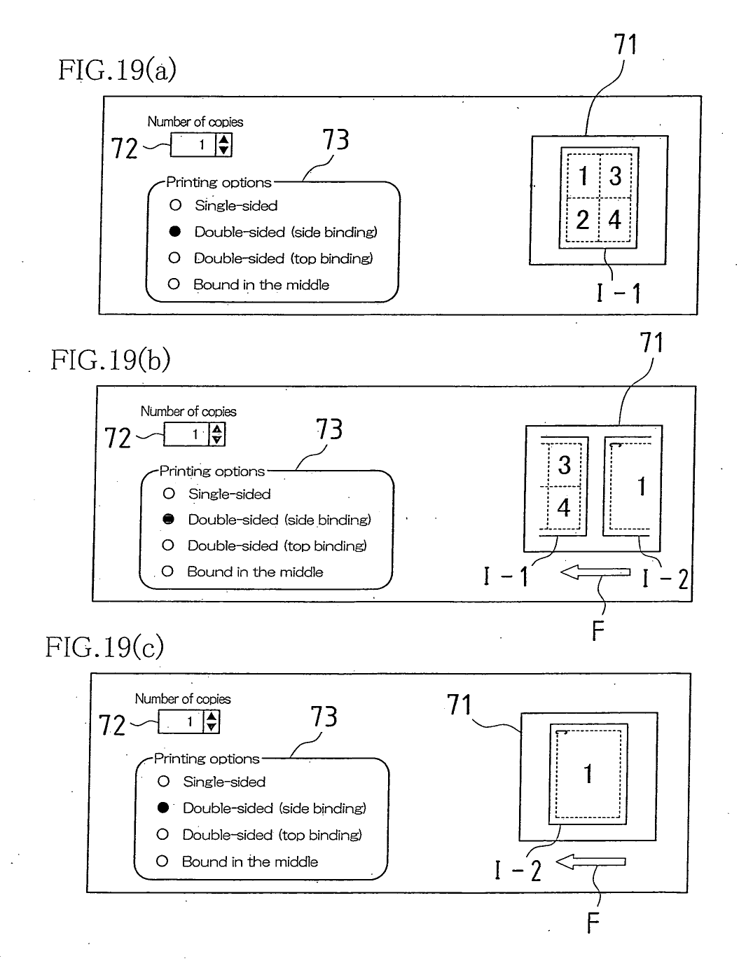

In the present embodiment, instead of displaying a cylinder body interface UI on the screen of the display device 57, a display area 71 is formed on the screen of the display device 57 as shown in FIG. 19(a) through FIG. 19(c), and a plurality of icons I-1, I-2, . . . are endlessly displayed repeated in sequence in the display area 71, continuously moving the icons across the display area 71 in a horizontal direction F, allowing the icons displayed in the display area 71 to be selectively pointed.

In FIG. 19(a) through FIG. 19(c), the number of copies field 72 and the printing options (double-sided setting) field 73 on the left side of the screen are functions with a high frequency of use and are permanently displayed.

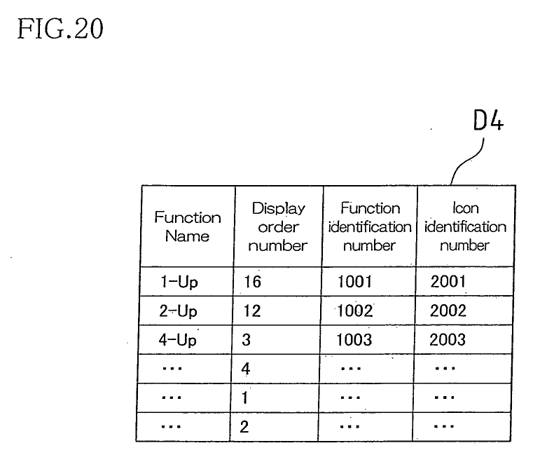

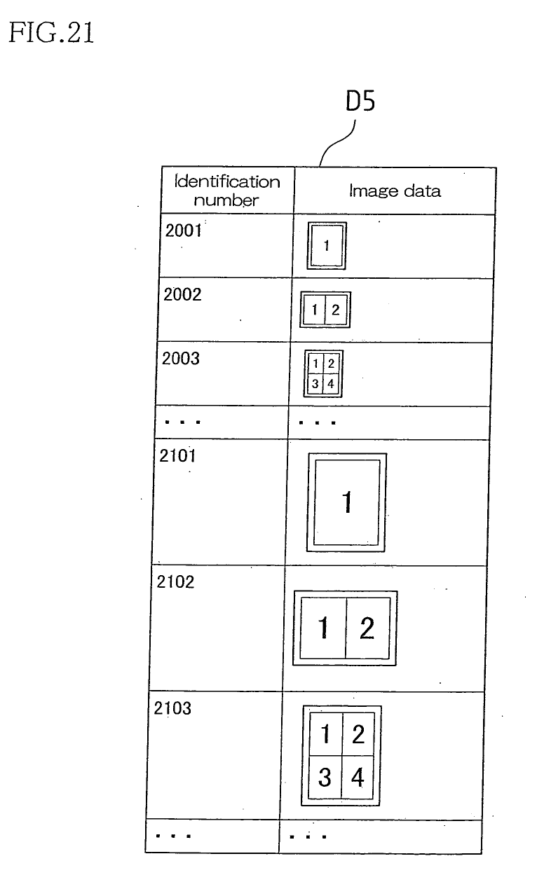

For example, if the application software 12 is a driver for controlling the printer 55, the icons I-1, I-2, . . . for controlling the printer are endlessly displayed repeated in sequence in the display area 71, and icons in the display area 71 are pointed. In this case, an administration data table D4 as shown in FIG. 20 and an icon data table D5 as shown in FIG. 21 need to be stored in the hard disk drive 54 ahead of time.

The administration data table D4 in FIG. 20 stores information related to the icons I-1, I-2, . . . which are displayed in the display area 71. For example, the names of functions corresponding to the icons I-1, I-2, . . . , the display order and identification number of each function for the icons I-1, I-2, . . . , and the identification number of the icons I-1, I-2, . . . are stored, all cross-referenced.

The icon data table D5 in FIG. 21 stores the identification number of the icons I-1, I-2, . . . and the image data of the icons, all cross-referenced.

Next, a more detailed description is provided of the display for controlling a printer.

First, the controlling portion 3 references the administration data table D4 and the icon data table D5 in the hard disk drive 54 via the storage portion 5 and reads from the administration data table D4 the display order and the identification numbers of the icons I-1, I-2, . . . and then reads from the icon data table D5 the image data corresponding to the identification numbers of the icons I-1, I-2, . . . . The controlling portion 3 then gives the display order, the identification numbers, and the image data of the icons I-1, I-2, . . . to the display driving portion 4. The display driving portion 4 controls the drive of the display device 57 via the operating system OS and the function processing portion 2, and then, on the screen of the display device 57, forms the display area 71 on the screen of the display device 71 as shown in FIG. 19(a) though FIG. 19(c), and endlessly displays repeated in sequence the icons I-1, I-2, . . . shown by the image data in the display order of the icons across the display area 71 in the horizontal direction F. At this time, the controlling portion 3 monitors the display status of the display area 71 via the display driving portion 4.

In this state, the user can view each of the icons I-1, I-2, . . . . in sequence even on a small screen.

As the icons I-1, I-2, . . . are displayed in this manner, the user can perform a clicking operation with the pointing device 60 timed with the display of a desired icon in the display area 71 to point the desired icon. In response, the controlling portion 3 stops the movement of the icons across the display area 71 via the display driving portion 4 and displays the desired icon in the display area 71. The controlling portion 3 sets the function corresponding to the desired icon. The controlling portion 3 then restarts the endless display of the icons across the display area 71 via the display driving portion 4 once the function is set.

Similarly, thereafter, whenever an instruction is given to begin printing by operating the pointing device 60 after all the necessary icons have been pointed and all the necessary functions have been set, this instruction is sent to the controlling portion 3 via the operating system OS and the function processing portion 2, and in response the application software 12 controls the printer 55 via the function processing portion 2 and the operating system OS, and printing is performed using all the necessary functions.

In the present embodiment, since only a plurality of icons is endlessly repeatedly displayed in sequence in the display area 71, program processing can be significantly cut and the load on the personal computer reduced compared to the display of the cylinder body interface UI described above.

Instead of moving the icons continuously across the display area 71, the icons may be moved intermittently, stopping each icon displayed in the display area 71 for a certain amount of time. In this case, the desired icon is displayed in the display area 71 longer enough to make it easier to point that icon by a clicking operation with the pointing device 60.

It is also possible to display the plurality of icons in sequence in the display area 71 one at a time as in stop-frame photography, instead of moving the icons across the display area 71.

Alternatively, in response to an operation by the pointing device 60, etc., the movement of icons may be stopped in the display area 71, the movement of the icons may be restarted, the display order of the icons may be reversed, or the movement speed of the icons may be changed.

Further, as in the first embodiment, enlarged icons and description information, etc., may be displayed when an icon is selectively pointed.

Alternatively, when the needed icon is pointed, the needed icon may be displayed in a history information display window, and when other functions are limited due to a function of an icon which has already been set, the display of the other functions may be changed or description information may be displayed regarding the limitation of the other functions.

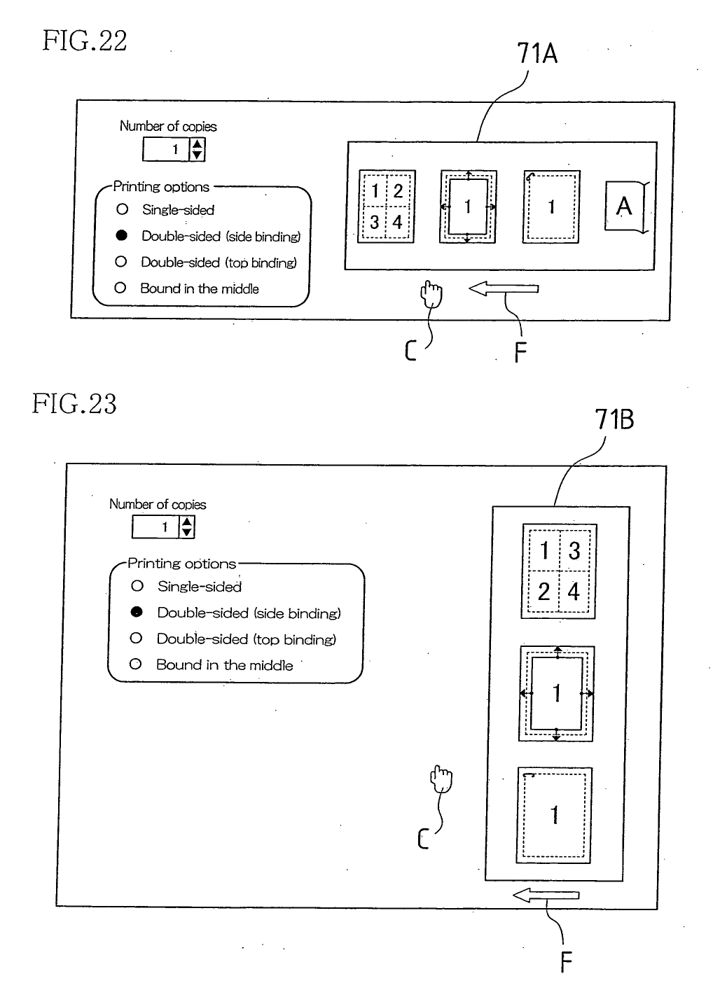

FIG. 22 shows a variation of the display area formed on the screen of the display device 57. This display area 71A is wider than the display area 71 of FIG. 19(a) through FIG. 19(c) and can display four icons at once.

Here, the icons I-1, I-2, . . . are endlessly displayed four at once in the order of the icons repeated in sequence across the display area 71 in the horizontal direction F. When the cursor C is placed over any of the icons in the display area 71A and a clicking operation is performed, the controlling portion 3 stops the movement of the icons in the display area 71A and immediately sets the function corresponding to the icon displayed in the display area 71A. Thereafter, the display of the icons in the display area 71A returns to its original state.

FIG. 23 shows another variation of the display area formed on the screen of the display device 57. This display area 71B is longer than the display area 71 of FIG. 19(a) through FIG. 19(c) and can display three icons at once lined up vertically.

Here, with the there icons lined up vertically in the display area 71, the icons I-1, I-2, . . . are endlessly displayed repeatedly three at a time across the display area 71 in the horizontal direction F. When the cursor C is placed over any of the icons in the display area 71B and a clicking operation is performed, the controlling portion 3 stops the movement of the icons in the display area 71B and immediately sets the function corresponding to the icon displayed in the display area 71B. Thereafter, the display of the icons in the display area 71B returns to its original state.

If the icons are displayed in this manner lined up vertically, the display period for all the icons is shortened, and all the icons can be viewed in a short time.

### THIRD EMBODIMENT

Next, a third embodiment of the interface according to the present invention will be described.

The interface according to the present embodiment is configured in a similar fashion to the interface 11 of FIG. 1. The personal computer, printer, and so on which make up the interface 11 are also identical to those shown in FIG. 15.

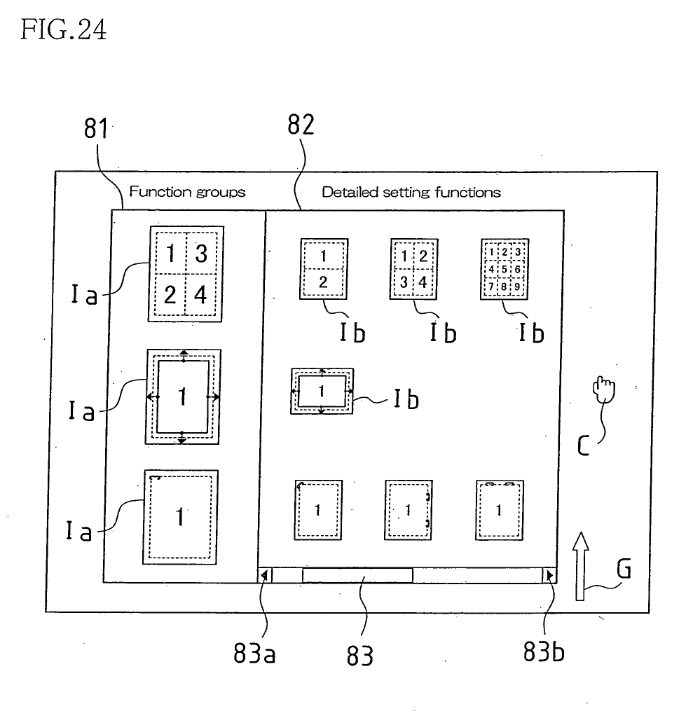

In the present embodiment, a main display area 81 and a sub display area 82 are formed on the screen of the display device 57 as shown in FIG. 24, and icons are endlessly displayed repeated in sequence while moving continuously up both display areas 81 and 82 in a vertical direction G, allowing the icons to be selectively pointed.

Here, a plurality of icons are divided into a plurality of function groups, and a representative icon Ia which represent the function group is displayed for each function group in the main display area 81, and subsidiary icons Ib for each function which belongs to the function group are displayed lined up horizontally next to the representative icon Ia in the sub display area 82. The representative icon Ia and the subsidiary icons Ib for one function group are always displayed in a horizontal row. Accordingly, the movement of the representative icon Ia in the main display area 81 and the movement of the subsidiary icons Ib in the sub display area 82 are synchronized.

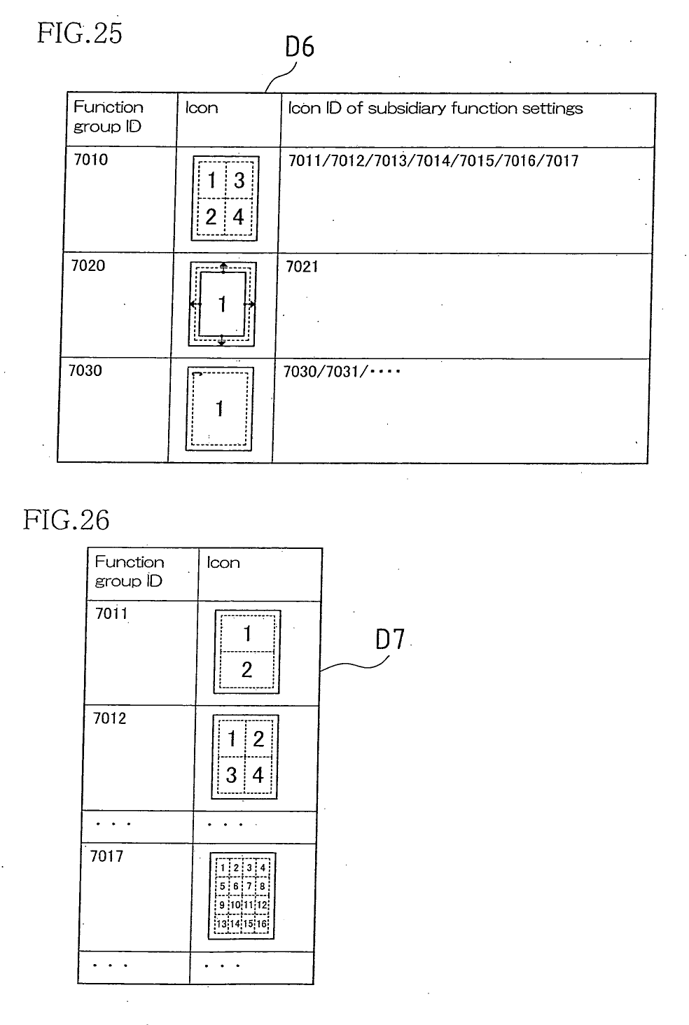

When the representative icon Ia and the subsidiary icons Ib are displayed separately in the main display area 81 and the sub display area 82 in this way, a representative icon data table D6 as shown in FIG. 25 and a subsidiary icon data table D7 as shown in FIG. 26 need to be stored ahead of time in the hard disk drive 54.

The representative icon data table D6 in FIG. 25 stores the identification number of the each representative icon Ia, the image data of each representative icon Ia, and the identification numbers of the subsidiary icons Ib for each function which belongs to the function group of the representative icon Ia, all cross-referenced.

The subsidiary icon data table D7 in FIG. 26 stores the identification number of the subsidiary icons and the image data of the subsidiary icons, all cross-referenced.

The identification numbers of the icons in both the representative icon data table D6 and the subsidiary icon data table D7 are cross-referenced with the display order and the functions corresponding to each icon. Of course, the display order of each icon and the identification numbers of each function may be set and stored separately, as in the administration data table D1 in FIG. 3.

Next, a more detailed description is provided of the display for controlling a printer.

The controlling portion 3 references the representative icon data table D6 in the hard disk drive 54 via the storage portion 5 and, for each representative icon Ia, reads from the representative icon data table D6 the identification number of the representative icon Ia, the image data of the representative icon Ia, and the identification numbers of the subsidiary icons Ib of each function belonging to the function group of the representative icon Ia. The controlling portion 3 references the subsidiary icon data table D7 and reads from the subsidiary icon data table D7 the identification number and the image data of the subsidiary icons Ib. The controlling portion 3 then provides the read data to the display driving portion 4.

The display driving portion 4 controls the drive of the display device 57 via the operating system OS and the function processing portion 2, and on the screen of the display device 57 forms a main display area 81 and a sub display area 82 on the screen of the display device 57 as shown in FIG. 24, and displays the representative icons Ia in the main display area 81 three at a time lined up vertically. Then, for each representative icon Ia, the display driving portion 4 selects the image data for the subsidiary icons Ib of each function belonging to the function group of the representative icon Ia and displays the subsidiary icons Ib of the functions belonging to the function group of the representative icon Ia horizontally in a line next to the representative icon Ia in the sub display area 82. The display driving portion 4 then endlessly displays repeated in sequence the representative icons Ia in a continuous movement across the main display area 81 in the vertical direction G, and, in synchronization with this, it endlessly displays repeated in sequence the subsidiary icons Ib in a continuous movement across the sub display area 82 in the vertical direction G.

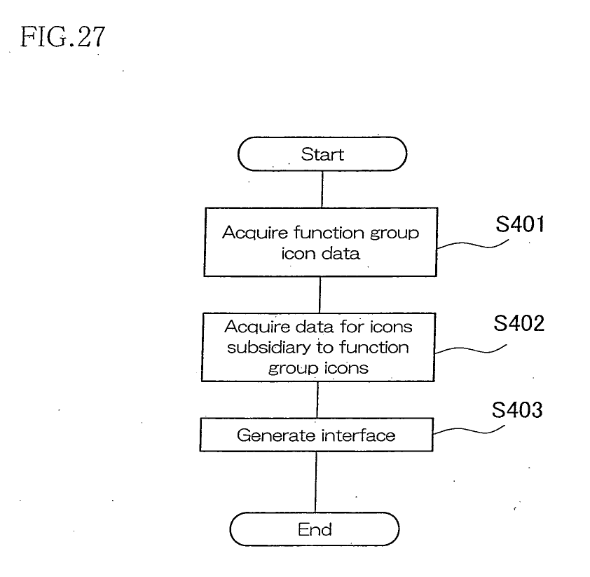

FIG. 27 is a flowchart showing the steps in the process up until formation the main display area 81 and the sub display area 82 on the screen of the display device 57.

First, for each representative icon Ia, the controlling portion 3 reads from the representative icon data table D6 the identification number of the representative icon Ia, the image data of the representative icon Ia, and the identification numbers of the subsidiary icons Ib of the functions belonging to the function group of the representative icon Ia (step S401), reads from the subsidiary icon data table D7 the identification numbers and image data of the subsidiary icons (step S402), and then provides the read data to the display driving portion 4.

The display driving portion 4 forms the main display area 81 and the sub display area 82 on the screen of the display device 57, displays each representative icon in the main display area 81 three at a time lined up and moving in the vertical direction G, and displays the subsidiary icons Ib of the functions belonging to the function group of the representative icon Ia in the sub display area 82 lined up horizontally next to the representative icon Ia and moving in the vertical direction G (step S403).

When the cursor C is moved to either button 83a or button 83b in a scrollbar 83 in the sub display area 82 and a clicking operation is performed with the pointing device 60, in response the controlling portion 3 determines which scroll direction of the buttons 83a or 83b was pointed via the display driving portion 4, and moves the subsidiary icons Ib of the sub display area 82 in the pointed scroll direction. This makes it possible to display all the subsidiary icons Ib, even if there are more subsidiary icons Ib than the number which can be displayed at once in a single horizontal line in the sub display area 82.

With this display in the main display area 81 and the sub display area 82, the controlling portion 3 monitors the display status of the main display area 81 and the sub display area 82 via the display driving portion 4.

In this state, the user can see the representative icons Ia in the main display area 81, check the function group of each representative icon Ia, in other words get a general understanding of several functions, and then look at the subsidiary icons Ib lined up horizontally next to the representative icon Ia, and check details of several functions.

At this time, the user can operate the pointing device 60 to move the cursor C on the screen in FIG. 24 over one of the subsidiary icons Ib and perform a clicking operation with the pointing device 60 and selectively point the desired subsidiary icon Ib. In response, the controlling portion 3 stops the movement of the icons across the display areas 81 and 82 via the display driving portion 4 and sets the function corresponding to the desired subsidiary icon Ib. The controlling portion 3 then restarts the endless display of the icons across the display areas 81 and 82 via the display driving portion 4 once the function corresponding to the desired subsidiary icon Ib is set.

Similarly, thereafter, whenever an instruction is given to begin printing by operating the pointing device 60 after all the necessary subsidiary icons Ib have been pointed and all the necessary functions have been set, this instruction is sent to the controlling portion 3 via the operating system OS and the function processing portion 2, and in response the application software 12 controls the printer 55 via the function processing portion 2 and the operating system OS, and printing is performed using all the necessary functions.

Instead of moving the icons continuously across the display areas 81 and 82, the icons may be moved intermittently, stopping each icon displayed in the display areas 81 and 82 for a certain amount of time.

Alternatively, in response to an operation by the pointing device 60, etc., the movement of icons may be stopped in the display area 71, the movement of the icons may be restarted, the display order of the icons may be reversed, or the movement speed of the icons may be changed.

Further, as in the first embodiment, enlarged icons and description information, etc., may be displayed when an icon is selectively pointed.

Alternatively, when the needed icon is pointed, the needed icon may be displayed in a history information display window, and when other functions are limited due to a function of an icon which has already been set, the display of the other functions may be changed or description information may be displayed regarding the limitation of the other functions.

Incidentally, if the main display area 81 and the sub display area 82 are formed on the screen of the display device 57 and a plurality of icons are displayed in each of the main display area 81 and the sub display area 82, the number of icons displayed grows making it difficult to check each icon individually.

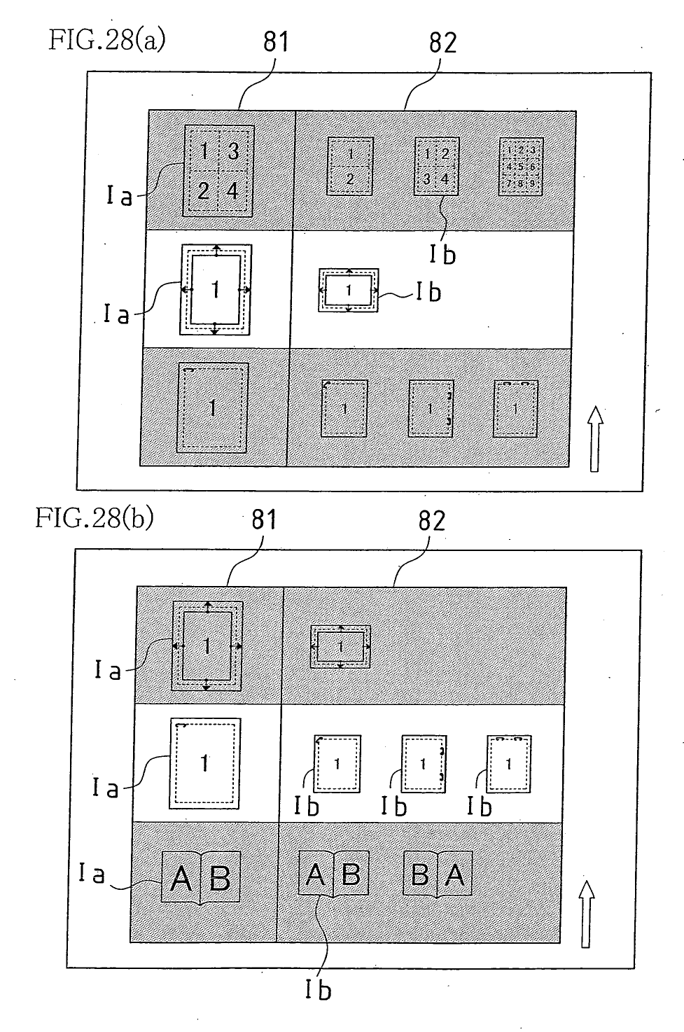

It is therefore possible to display representative icon Ia in the center of the main display area 81 and the subsidiary icons Ib lined up horizontally next to the representative icon Ia in the sub display area 82, in other words, the center horizontal line of icons, brighter, as shown in FIG. 28(a) and FIG. 28(b), and display the horizontal line of icons above and the horizontal line of icons below darker. This makes it easier for the user to focus on the center horizontal line of icons and check. It is also possible to refer to the horizontal line of icons above and the horizontal line of icons below.

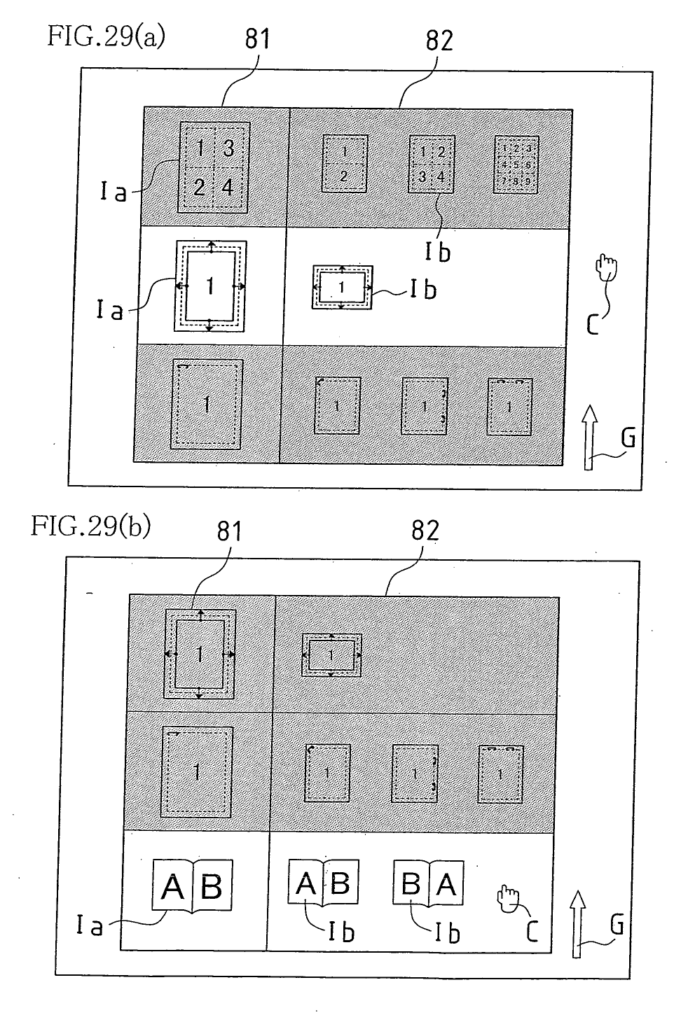

Further, it is also possible to display the horizontal line of icons over which the cursor C is placed brighter, as shown in FIG. 29(a) and FIG. 29(b), and display the other horizontal lines of icons darker.

In this case, the user can operate the pointing device 60 to move the cursor C to a position over the desired horizontal line, causing the desired horizontal line to be displayed brighter for easy checking.

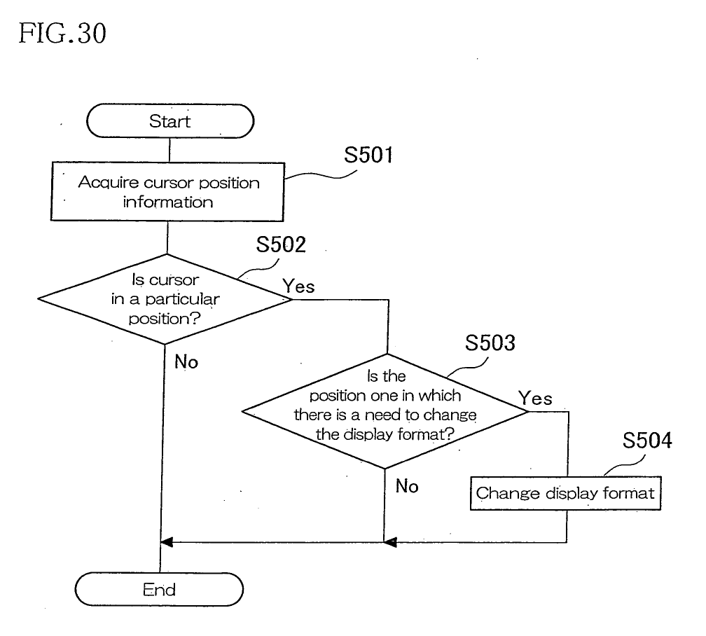

FIG. 30 is a flowchart showing the steps in a process for displaying the desired horizontal line in the main display area 81 and the sub display area 82 brighter.

First, the controlling portion 3 acquires the position of the cursor C via the display driving portion 4 (step S501) and determines whether the position of the cursor C is in the main display area 81 or the sub display area 82 (step S502), and terminates process if the position of the cursor C not in the main display area 81 or the sub display area 82 (“No” at step S502).

If the position of the cursor C is in either the main display area 81 or the sub display area 82 (“Yes” at step S502), the controlling portion 3 determines whether or not the horizontal line with which the cursor C is overlapping is being displayed brighter already, and deems there to be no need to change the display status if the horizontal line is already being displayed brighter (“No” at step S503), and terminates the process without changing the display status. If horizontal line with which the cursor C is overlapping is not being displayed brighter, the controlling portion 3 deems there to be a need to change the display status (“Yes” at step S503), displays darker the horizontal line which was displayed brighter until then, and displays brighter the horizontal line with which the cursor C is overlapping (step S504).

Instead of displaying the icons in the desired horizontal line brighter, it is also possible to change the color of the icons or decorate the icons in the desired horizontal line.

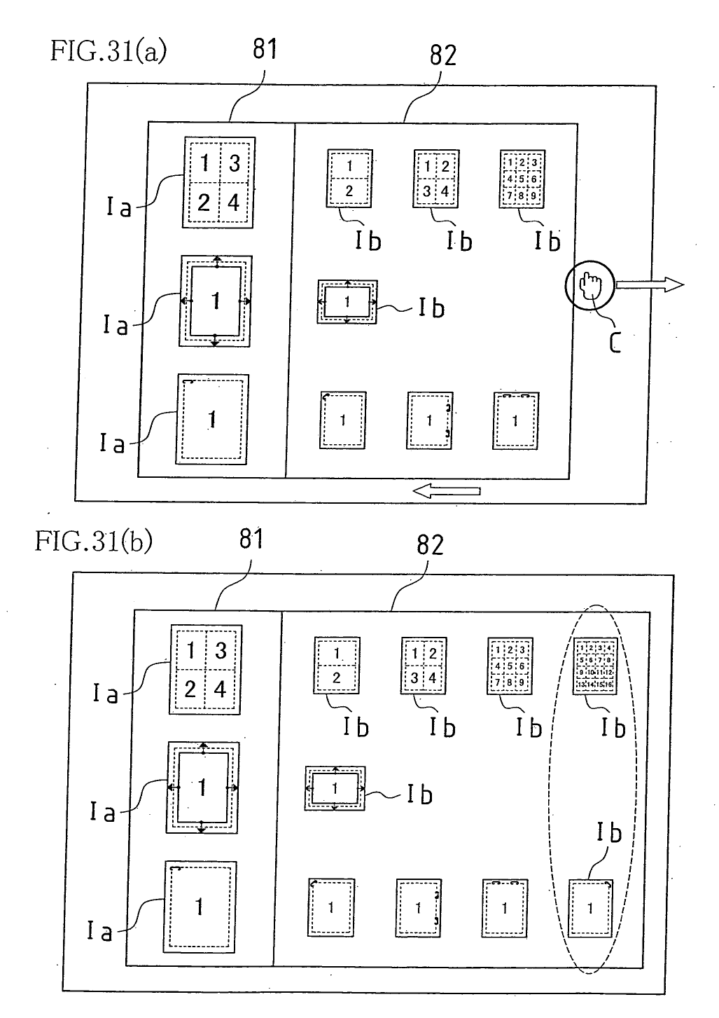

It is also possible to change the width of the sub display area 82 as shown in FIG. 31(a) and FIG. 31(b). By doing this, it is possible to change the number subsidiary icons which can be displayed at once in the sub display area 82.

In this case, the pointing device 60 is operated to move the cursor C to the right edge of the sub display area 82 and move the cursor C right and left while performing a clicking operation with the pointing device 60 (called “drag and hold”). In response, the controlling portion 3 moves the right edge of the sub display area 82 right and left in accordance with the cursor C, changing the width of the sub display area 82.

In the above embodiments, icons were used as an example, but indicators and so on which play the same role as icons may be displayed instead of icons. Indicators include symbols, codes, character strings, and so on printed such that the content of each type of function can be easily understood.

The present invention may be embodied in a wide variety of forms other than those presented herein without departing from the purport or essential characteristics thereof. The foregoing embodiments, therefore, are in all respects merely illustrative and are not to be construed in limiting fashion. The scope of the present invention being as indicated by the claims, it is not to be constrained in any way whatsoever by the body of the specification. All modifications and changes within the range of equivalents of the claims are, moreover, within the scope of the present invention.

1. An interface that displays icons or indicators corresponding to a plurality of functions on a screen and selectively points each icon or indicator on the screen, the interface comprising:
a display controlling means for displaying each icon or indicator repeatedly in sequence on the screen; and
an input operating means for selectively pointing an icon or indicator on the screen.

2. An interface that displays icons or indicators corresponding to a plurality of functions on a screen and selectively points each icon or indicator on the screen, the interface comprising:
a display controlling means for displaying a rotator on the screen, placing each icon or indicator on a circumferential face of the rotator, and sequentially displaying each icon or indicator by rotating the rotator; and
an input operating means for selectively pointing each icon or indicator on the circumferential face of the rotator.

3. The interface according to claim 2, wherein the display controlling means stops the rotation of the rotator when the rotator is instructed to stop by the input operating means.

4. The interface according to claim 2, wherein the display controlling means changes the speed of rotation or the direction of rotation of the rotator when the rotator is instructed to change the speed of rotation or the direction of rotation by the input operating means.

5. The interface according to claim 2, wherein when an icon or indicator on the circumferential face of the rotator is pointed by the input operating means, the display controlling means places and displays at least one other icon or indicator related to the pointed icon or indicator on the circumferential face of the rotator.

6. The interface according to claim 2, wherein when an icon or indicator on the circumferential face of the rotator is pointed by the input operating means, the display controlling means enlarges the pointed icon or indicator.

7. The interface according to claim 2, wherein when an icon or indicator on the circumferential face of the rotator is pointed by the input operating means, the display controlling means displays information related to the pointed icon or indicator.

8. The interface according to claim 2, wherein when an instruction to change the position of an icon or indicator on the circumferential face of the rotator is given by the input operating means, the display controlling means changes the position of the icon or indicator on the circumferential face of the rotator.

9. The interface according to claim 2, wherein when an icon or indicator on the circumferential face of the rotator is pointed by the input operating means, the display controlling means changes the display of other icons or indicators which are suppressed from being pointed together with the pointed icon or indicator.

10. The interface according to claim 9, wherein the display controlling means displays information related to other icons or indicators which are suppressed from being pointed together with the pointed icon or indicator.

11. The interface according to claim 2, wherein the display controlling means displays at least one icon or indicator pointed by the input operating means in a history information display region which is different from the rotator.

12. The interface according to claim 2, wherein the display controlling means displays on the screen at least one button for controlling operation of the rotator and controls the rotator, when this button is operated by the input operating means.

13. The interface according to claim 2 wherein the display controlling means repeatedly rotates and pauses the rotator.

14. An interface that displays icons or indicators corresponding to a plurality of functions on a screen and selectively points each icon or indicator on the screen, the interface comprising:
a display controlling means for forming a display area on the screen and repeatedly displaying each icon or each indicator in sequence while moving at least one icon or indicator across this display area; and
an input operating means for selectively pointing an icon or indicator displayed in this display area.

15. The interface according to claim 14, wherein the display controlling means intermittently moves the icons or the indicators across the display area.

16. The interface according to claim 14, wherein the display controlling means displays a plurality of icons or indicators lined up in one direction in the display area and moves the icons or the indicators in the one direction across the display area.

17. The interface according to claim 14, wherein the display controlling means displays a plurality of icons or indicators lined up in one direction in the display area and moves the icons or the indicators in synchronization in another direction that intersects with the one direction across the display area.

18. The interface according to claim 17, wherein the plurality of icons or indicators displayed lined up in one direction in the display area is made up of icons or indicators and other icons or indicators which belong to the icons or the indicators.

19. The interface according to claim 17, wherein the plurality of icons or indicators displayed lined up in one direction in the display area is icons or indicators which correspond to a plurality of functions which belongs to the same function group.

20. The interface according to claim 14, wherein the display controlling means displays a plurality of icons or indicators in the display area in rows and columns, moving the icons or indicators in synchronization along each row or column across the display area, and differentiating the display status of one row or column from the display status of other rows or columns.

21. The interface according to claim 20, wherein the display status of one row or column pointed by a cursor on the screen is differentiated from the display status of other rows or columns.

22. The interface according to claim 14, wherein:
the input operating means instructs the display controlling means to enlarge or reduce the display area based on input operations of the input operating means; and
the display controlling means responds to the instruction to enlarge or reduce the display area from the input operating means by enlarging or reducing the display area.

23. The interface according to claim 1, wherein the functions are functions for controlling a printer, the interface being used for controlling the printer.

24. The interface according to claim 1, wherein the icons or indicators are for setting a printing layout for printed matter to be printed by a printer.

25. The interface according to claim 1, provided with a function executing means for executing functions corresponding to icons or indicators pointed by the input operating means.

26. An interface program executable on a computer for displaying icons or indicators corresponding to a plurality of functions on a screen and selectively pointing each icon or indicator on the screen, the interface program including:
a display controlling step of displaying each icon or indicator repeatedly in sequence on the screen; and
an input operating step of selectively pointing an icon or indicator on the screen.

27. An interface program executable on a computer for displaying icons or indicators corresponding to a plurality of functions on a screen and selectively pointing each icon or indicator on the screen, the interface program including:
a display controlling step of displaying a rotator on the screen, placing each icon or indicator on a circumferential face of the rotator, and sequentially displaying each icon or indicator by rotating the rotator; and
an input operating step of selectively pointing each icon or indicator on the circumferential face of the rotator.

28. An interface program executable on a computer for displaying icons or indicators corresponding to a plurality of functions on a screen and selectively pointing each icon or indicator on the screen, the interface program including:
a display controlling step of forming a display area on the screen and repeatedly displaying each icon or each indicator in sequence in this display area while moving each icon or indicator across this display area; and
an input operating step of selectively pointing an icon or indicator displayed in this display area.

29. The interface according to claim 2, wherein the functions are functions for controlling a printer, the interface being used for controlling the printer.

30. The interface according to claim 2, wherein the icons or indicators are for setting a printing layout for printed matter to be printed by a printer.

31. The interface according to claim 2, provided with a function executing means for executing functions corresponding to icons or indicators pointed by the input operating means.

32. The interface according to claim 14, wherein the functions are functions for controlling a printer, the interface being used for controlling the printer.

33. The interface according to claim 14, wherein the icons or indicators are for setting a printing layout for printed matter to be printed by a printer.

34. The interface according to claim 14, provided with a function executing means for executing functions corresponding to icons or indicators pointed by the input operating means.
